(19) United States
(12) Patent Application Publication
(10) Pub. No.: US 2012/0324376 A1
(43) Pub. Date: Dec. 20, 2012

(54) APPARATUS FOR IMPLEMENTING WEB-BASED USER INTERFACE FOR COMMUNICATION TERMINAL AND METHOD THEREOF

(76) Inventor: Se Chul Hong, Seongnam-si (KR)

(21) Appl. No.: 13/142,254

(22) PCT Filed: Dec. 9, 2010
(86) PCT No.: PCT/KR10/08814

§ 371 Date: Jun. 24, 2011

(30) Foreign Application Priority Data
Mar. 12, 2010 (KR) 1020100022146
Dec. 9, 2010 (KR) 1020100125604

(51) Int. Cl. G06F 3/01

(52) U.S. Cl. 715/762

(57) ABSTRACT

Provided are an apparatus for implementing a web-based user interface for a communication terminal connected to a communication network and a method thereof. The apparatus includes a script execution layer included in the communication terminal, for receiving a script program from a program server and executing the script program together with a platform library; the platform library included in the communication terminal; a program manager included in a program server, designated with a URL by the script execution layer, and downloaded to and executed by the communication terminal; the program manager server included in the program server, for managing interface configuration information of the communication terminal for each user and providing the interface configuration information data file in response to a request from the program manager; and the script program included in the program server and produced using a script and the platform library.

### CROSS-REFERENCE TO RELATED APPLICATION

This application claims the benefit of Korean Application No. 10-2010-0022146, filed on Mar. 12, 2010, and Korean Patent Application No. 10-2010-0125604, filed on Dec. 9, 2010, with the Korean Intellectual Property Office, the disclosure of which is incorporated herein by reference.

### BACKGROUND

1. Field of the Invention

The present invention relates to an apparatus for implementing a web-based user interface for a communication terminal connected to a communication network and a method thereof.

2. Discussion of Related Art

In a conventional technique, user interface layer software is installed on a terminal operating system (OS), program manager software is installed on the user interface layer software, and this program manager performs a function of starting up an application program so that a terminal user interface is provided to a user.

A structure of the user interface usually consists of hierarchical menus or icons. An end of the menu and the icon consists of a link for execution of the application program. When this menu or icon is selected, the program is executed. Further, there is a terminal in which some templates are provided to a memory of the terminal in advance and selected, to support users' needs. Further, some general-purpose OS terminals provide a function of variously modifying a screen structure, icons, backgrounds, and images of a program manager.

This conventional technique has a problem in that the program manager is fixed for a communication terminal when the communication terminal is released, such that functions other than those provided by the terminal are unavailable to a user. Thus, the released terminal has a fixed user interface and cannot provide a variety of functions other than limited functions implemented in advance, and cannot have a dynamically variously changed screen.

From a point of view of a terminal developer, the terminal developer must install, develop and test this user interface program in respective released terminals and iteratively perform a similar task on the terminals of a number of models. As a result, the terminal developer must individually perform maintenance of the respective terminals. Even when a user notices defects of the user interface program of the released terminal, in fact, it is difficult to add, enhance and replace a function without a manufacturer collecting the user terminal and reinstalling the user interface program. Accordingly, even when a further enhanced interface is mounted to a new model, a user of an old model must use an existing user interface as it is.

Finally, from a point of view of communication providers, provider terminals have a different interface according to manufacturers and release years of the terminals. Accordingly, it is difficult to provide a unified interface and it is impossible to modify an existing interface of a terminal.

### SUMMARY OF THE INVENTION

The present invention has been made to resolve the aforementioned problems, and the present invention is directed to an apparatus for implementing a web-based user interface for a communication terminal and a method thereof in which an overall user interface of the communication terminal consists of a web site controlled through a program server to realize a dynamically variously changed screen configuration, a script program constituting the user interface can be downloaded from a server, instead of being separately installed, and immediately executed in the communication terminal, a service provided by a portal site can be used as a basic user interface of the communication terminal, and a manager function for a general binary program installed in the communication terminal as well as a script program can be provided by a single interface.

According to an aspect of the present invention, there is provided an apparatus for implementing a web-based user interface for a communication terminal, the apparatus including: a script execution layer included in the communication terminal, for receiving a script program from a program server and executing the script program together with a platform library; the platform library included in the communication terminal, for providing at least one function of a graphic user interface, screen rearrangement, context management, terminal engine compatibility, communication, data storage and management, dynamic module management, and animations and effects to the script program; a program manager included in a program server, designated with a URL by the script execution layer, and downloaded to and executed by the communication terminal, the program manager configuring a terminal user interface based on an interface configuration information data file provided from a program manager server; the program manager server included in the program server, for managing interface configuration information of the communication terminal for each user and providing the interface configuration information data file in response to a request from the program manager; and the script program included in the program server and produced using a script and the platform library.

According to another aspect of the present invention, there is provided a method of implementing a web-based user interface for a communication terminal, the method including: (a) executing a script execution layer of the communication terminal and downloading a program manager of a program server by means of a URL; (b) creating, by a program manager server, an interface configuration information data file based on customer setup information corresponding to the communication terminal in response to a request from the program manager, configuring the customer setup information using a basic template in advance when there is no customer setup information, and providing the created interface configuration information data file to the program manager; (c) analyzing, by the program manager, the interface configuration information data file and configuring the user interface in the communication terminal; and (d) analyzing, by the program manager, dynamic execution information included in the interface configuration information data file, connecting to a URL of a program in an “executed” state, and downloading and executing a corresponding script program.

According to still another aspect of the present invention, there is provided a method of managing a program in a web-based user interface according to the present invention, the method including: (a) receiving, by a web-based user interface, a program selection from a user; (b) identifying, by a program manager, a type of a program based on link information of the program; (c) when the type of the program indicates a script program, connecting to a URL of the script program and downloading and executing the script program, wherein, when the script program is a program deactivated due to program switching by a user, a script program stored in a temporary storage of the communication terminal is directly executed; and (d) when the program type indicates a general binary program, executing the general binary program by means of an operating system, wherein the program manager manages a state of the general binary program by a general program manager of a script execution layer providing a program execution state to the program manager using a system call of the operating system.

In the method of managing a program in a web-based user interface, when the script program includes a context management function in step (c), the method further includes: (c1) loading a context of the script program managed by a platform library directly after the script program is executed; and (c2) storing a change of a screen and data resulting from execution of the script program, in the context of the script program.

According to yet another aspect of the present invention, there is provided a method of adding a program to a web-based user interface, the method including: (a) receiving, by a program manager, a selection of a program-adding function from a user; (b) downloading, by the program manager, a setup program to a communication terminal such that the setup program is executed, and receiving, by the setup program, a general binary program list from a general program manager of a script use layer and a list of script programs and general binary programs available to the user from a program manager server; and (c) when a program added by the user is a general binary program installed in the communication terminal, (c1) receiving, by the setup program, program information of the general binary program from the general program manager and delivering the program information together with information on a screen location at which the general binary program is to be added, to the program manager server to request registration; (c2) registering, by the program manager server, the program information and the screen location information in customer setup information, creating an interface configuration information data file based on changed customer setup information, and delivering the interface configuration information data file to the program manager; and (c3) analyzing, by the program manager, the interface configuration information data file and displaying an icon and information of the registered program.

According to yet another aspect of the present invention, there is provided a method of adding a program to a web-based user interface, the method including: (a) receiving, by a program manager, a selection of a program-adding function from a user; (b) downloading, by the program manager, a setup program to the communication terminal such that the setup program is executed, and receiving, by the setup program, a list of general programs installed by the user from a general program manager of a script use layer, and a list of script programs and general binary programs available to the user from a program manager server; and (c) when a program added by the user is a script program present in a program server, (c1) delivering, by the setup program, a program ID of the script program together with information on a screen location at which the script program is to be added, to the program manager server to request registration; (c2) registering, by the program manager server, program information corresponding to the program ID and the screen location information, in customer setup information, creating an interface configuration information data file based on changed customer setup information, and delivering the interface configuration information data file to the program manager; and (c3) analyzing, by the program manager, the interface configuration information data file and displaying an icon and information of a registered program.

According to yet another aspect of the present invention, there is provided a method of adding a program to a web-based user interface, the method including: a method of implementing a web-based user interface for a communication terminal, the method including: (a) receiving, by a program manager, a selection of a program-adding function from a user; (b) downloading, by the program manager, a setup program to the communication terminal such that the setup program is executed, and receiving, by the setup program, a list of general programs installed by the user from a general program manager of a script use layer, and a list of script programs and general binary programs available to the user from a program manager server; and (c) when a program added by the user is a general binary program in a program server, (c1) delivering, by the setup program, a program ID of the general binary program together with information on a screen location at which the general binary program is to be added, to the program manager server to request registration; (c2) registering, by the program manager server, program information corresponding to the program ID and the screen location information, in customer setup information; (c3) downloading, by the general program manager, an installation file for the general binary program and installing the general binary program in the communication terminal; (c4) creating, by the program manager server, an interface configuration information data file based on changed customer setup information and delivering the interface configuration information data file to the program manager; and (c5) analyzing, by the program manager, the interface configuration information data file and displaying an icon and information of a registered program.

According to yet another aspect of the present invention, there is provided an apparatus for implementing a web-based user interface for a communication terminal, the apparatus including: a program manager execution layer included in the communication terminal, responsible for use of an operating system (OS) function and execution of a script; a system program execution layer for executing a process for each system function according to the OS; a platform library included in the communication terminal, for providing at least one function of a graphic user interface, screen rearrangement, context management, terminal engine compatibility, communication, data storage and management, dynamic module management, and animations and effects, to a script program; an OS use layer for providing an interface for enabling the platform library to provide a function of a terminal system; a remote program manager package included in a program server, designated with a URL by a script execution layer, and downloaded to and executed by the communication terminal, the remote program manager package configuring a terminal user interface based on an interface configuration information data file provided from a program manager server; a market server included in the program server, for managing interface configuration information of the communication terminal for each user and providing the interface configuration information data file in response to a request from the remote program manager package; and a script program included in the program server and produced using the script and the platform library.

According to yet another aspect of the present invention, there is provided a method of implementing a web-based user interface for a communication terminal, the method including: (a) when the communication terminal is started up, executing a program manager execution layer by means of a function of an operating system (OS); (b) analyzing, by a general program manager, execution information of an installed application and extracting and storing an icon; (c) when there is an installed program manager in the communication terminal, executing the program manager; and (d) when there is no installed program manager in the communication terminal, connecting to a market server and downloading and executing a new program manager.

### Effects of the Invention

The present invention provides a user interface software layer capable of configuring a user interface using a standard script, instead of producing each user interface software layer of the communication terminal in the form of binary code that can be executed only in each terminal. Accordingly, a terminal having this software installed thereon is capable of driving the user interface of the present invention irrespective of the type of the terminal.

The platform library of the present invention is a user interface platform developed by a standardized web-based JavaScript, and enables application software to be developed using a script by providing functions such as a user graphic interface, data management, an OS function, server interworking, and the like. Accordingly, a script program developed using the platform library is downloaded from the server, instead of being separately installed, and directly executed in the terminal, such that the program can be enhanced any time.

Further, in the present invention, the overall terminal user interface is produced using such a script program. Accordingly, the user terminal interface configuration and a program for driving the interface are downloaded from the server and installed in the terminal.

Accordingly, since the platform library of the present invention is implemented by JavaScript and operated with HTML, CSS and JavaScript, an overall user interface of the communication terminal consists of a web site transferred and executed from the program server, a local terminal or a remote site, in a technical aspect. That is, the overall terminal user interface is configured of a web site and primary programs of the terminal are also configured of a web site. Thus, a program developed by a web site technique is referred to as a “script program” in the description of the present invention, and the script program is classified into a “program manager,” a “widget script,” an “application script,” and a “system script” according to use of the present invention.

Accordingly, a user is allowed to personalize the terminal user interface into a completely different form or to immediately replace the function of the program manager, to reproduce a screen of its own communication terminal as it is using a replaced communication terminal or a PC connected to the Internet, and to inquire and modify personal information such as an address book, SMS messages, and photographs.

From a point of view of a communication provider, an overall user interface of a terminal of the provider can be consistently maintained by dynamically managing design and development of the user terminal interface and communication program using the present invention. Further, the communication provider generally provides a variety of services through its own portal site. The portal site services are web-based such that the portal site services can be used as a basic user interface of a communication terminal of the user by interworking with the program manager of the present invention. That is, the portal site of the provider becomes a center of the user terminal interface.

Further, one important characteristic of the present invention is that the program manager of the present invention provides a manager function for an Internet site or a “script program” implemented by a web technique, as well as a “general binary program” installed in the communication terminal, in an integrated manner through a web-based interface. Accordingly, the user cannot recognize that the program manager interworks with the program server and operates by means of a web technique, and manages all types of programs using the same program manager. In addition, the “program manager” driven through a server, similar to the “remote program manager,” is equally applied.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 illustrates an overall module configuration and an interworking relationship of an apparatus for implementing a web-based user interface according to a first embodiment of the present invention;

FIG. 2 illustrates an internal structure of a script execution layer according to the first embodiment of the present invention;

FIG. 3 illustrates a procedure of outputting a user interface screen to a display of a communication terminal when the communication terminal is started up according to the first embodiment of the present invention;

FIG. 4 is part of step S117 in FIG. 3 and illustrates a procedure of dynamically executing a script program on a user interface screen;

FIG. 5 illustrates a script program execution procedure in a program manager according to the first embodiment of the present invention;

FIG. 6 illustrates a script program execution procedure in a program manager according to the first embodiment of the present invention, and shows a manner in which a program management policy of a terminal OS is utilized as it is in order to simultaneously execute several script programs;

FIG. 7 illustrates a procedure in which a program manager executes a general binary program according to the first embodiment of the present invention;

FIG. 8 illustrates a procedure in which a general binary program installed in a communication terminal is added to a user interface screen according to the first embodiment of the present invention;

FIG. 9 illustrates a procedure in which a script program among programs in a program server is added to the user interface screen according to the first embodiment of the present invention;

FIG. 10 illustrates a procedure in which a general binary program among programs in the program server is added to the user interface screen according to the first embodiment of the present invention;

FIG. 11 illustrates a context management function of a platform library according to the first embodiment of the present invention;

FIG. 12 illustrates a system structure and an interworking configuration according to a second embodiment of the present invention;

FIG. 13 illustrates a program manager execution layer module configuration according to the second embodiment of the present invention;

FIG. 14 illustrates a system program execution layer according to the second embodiment of the present invention;

FIG. 15 illustrates a program manager executing procedure according to the second embodiment of the present invention;

FIG. 16 illustrates a binary widget adding procedure according to the second embodiment of the present invention;

FIG. 17 illustrates a binary program installation and registration procedure according to the second embodiment of the present invention;

FIG. 18 illustrates a binary widget state modifying procedure according to the second embodiment of the present invention;

FIG. 19 illustrates a script program download procedure according to the second embodiment of the present invention;

FIG. 20 illustrates a widget script execution procedure according to the second embodiment of the present invention;

FIGS. 21 and 22 illustrate an application script execution procedure according to the second embodiment of the present invention; and

FIG. 23 illustrates a system script execution procedure according to the second embodiment of the present invention.

### DETAILED DESCRIPTION OF EXEMPLARY EMBODIMENTS

Exemplary embodiments of the present invention are disclosed herein. However, specific structural and functional details disclosed herein are merely representative for purposes of describing exemplary embodiments of the present invention, however, exemplary embodiments of the present invention may be embodied in many alternate forms and should not be construed as limited to exemplary embodiments of the present invention set forth herein. Like reference numerals in the drawings denote like elements.

Throughout this disclosure, when a part includes a component, it means that the part do not preclude the presence or addition of other components, but may include the other components, unless particularly mentioned otherwise.

Prior to explanation of the present invention, terms used herein are defined, as follows:

Communication terminal: A communication terminal connected to a data communication network, which has a dedicated operating system (OS) or a general-purpose OS and is capable of executing a web browser module. As such a communication terminal, most mobile communication terminals may be used. Alternatively, some wired communication terminals may be used.

HTML: Hyper-Text Markup Language

CSS: Cascading Style Sheet

DOM: Document Object Model

HTTP: Hyper-Text Transfer Protocol

Java script: Java script is produced by a script language provided in most web-based browsers and is capable of controlling web sites through DOMs and CSSs.

Web browser core module: A term defined in the present invention, which refers to HTML, CSSs, DOMs, a JavaScript engine or an HTTP communication module that is a core functional element of the web browser.

Context: A context indicates execution state information for a program/process. A program of which the execution stops analyzes this information and returns to an original execution state.

Template: A template is generally referred to as a style or a skin. The template refers to a collection of color, form, images, moving images, and sound files for collectively defining a form of an interface.

User interface screen: This refers to all of system and setup programs such as menus, program icons, calling, and the like for use of the communication terminal by a user.

User UX: UX is an abbreviation for “user experience” and has the same meaning as “user interface.”

User UX module: The user UX module refers to each element for configuring a screen of a graphic user interface (GUI). That is, the user UX module refers to each element such as a window, a list, an input control, an image viewer, and the like.

SMS message or SMS service: short message service

General binary program: A term defined in the present invention. The general binary program refers to a general program that is compiled with machine code or Java VM code of a terminal OS and executed.

Script program: A term defined in the present invention and referring to a site or a program configured using HTML, CSS and JavaScript. The script program further includes an image, a moving image, sound information, and the like.

Temporary storage/cache/caching: A general computer scheme. This refers to a scheme of temporarily storing and using frequently used data, which is not changed, in a high-speed storage.

Binary application and binary widget: This is for discrimination from a program operating as a script and refers to a program produced with unique code executed by an OS and a central processing unit (CPU) of a terminal, i.e., a native program.

Widget: A small program that occupies a space in a screen and is always displayed.

Hereinafter, the present invention will be described in detail with reference to the accompanying drawings.

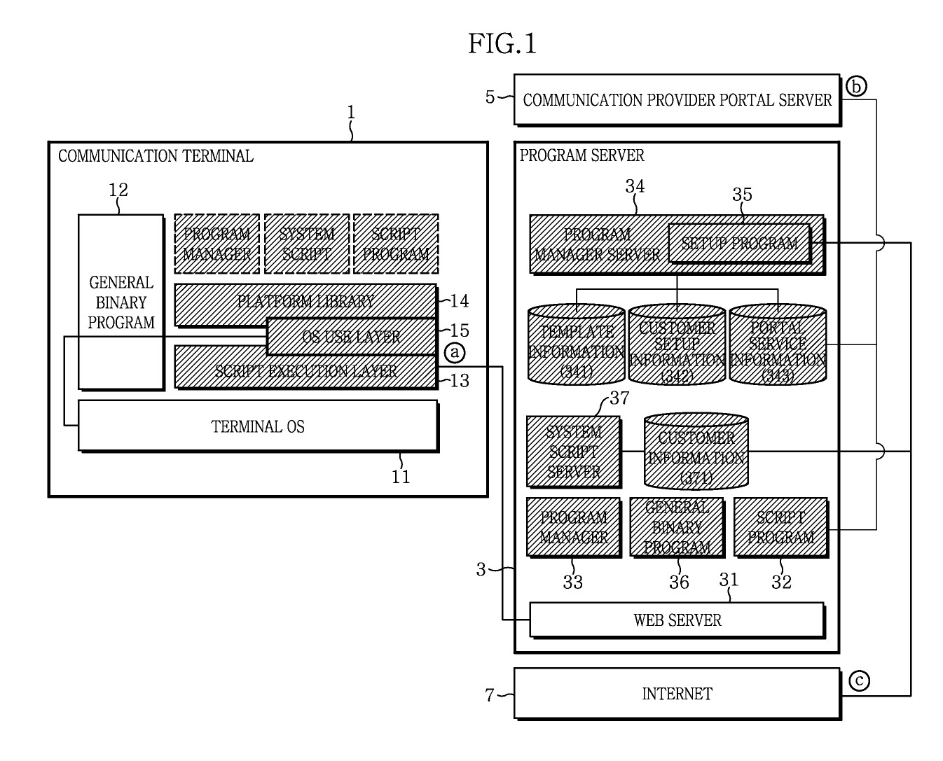

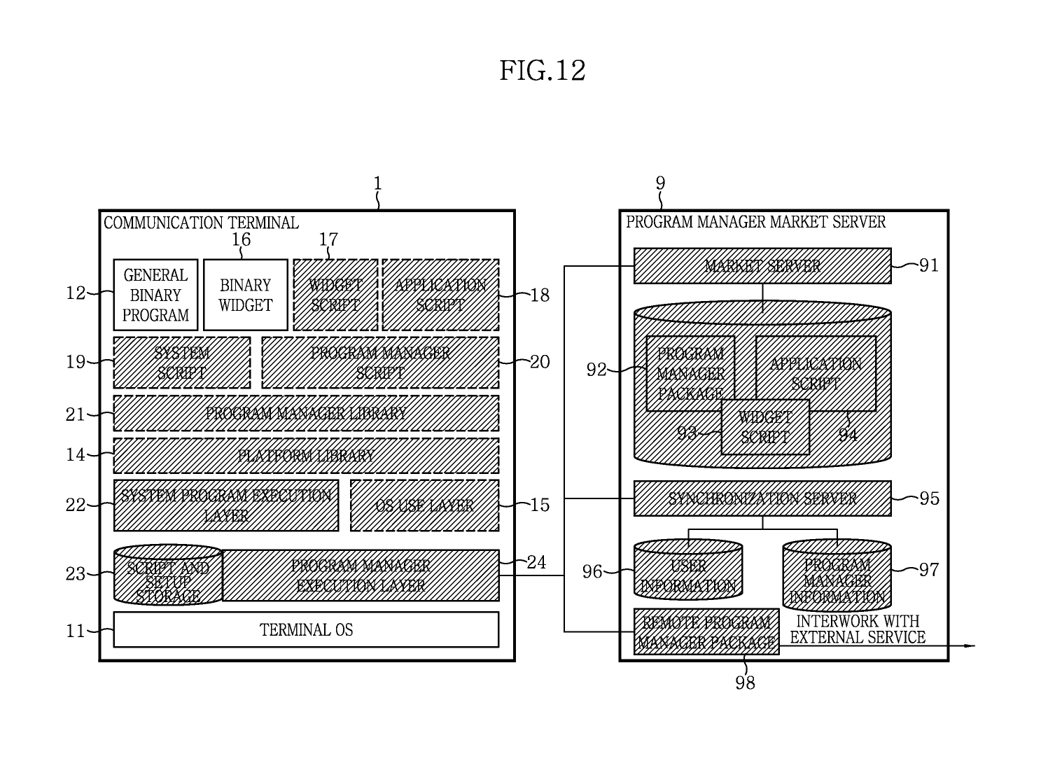

First, an apparatus for implementing a web-based user interface for a communication terminal and a method thereof according to a first embodiment of the present invention will be described with reference to FIGS. 1 to 11 and then, an apparatus for implementing a web-based user interface for a communication terminal and a method thereof according to a second embodiment of the present invention will be described with reference to FIG. 12 to FIG. 23.

In the first embodiment of the present invention, the web-based user interface is implemented by a script execution layer, a platform library, a program manager and a program manager server. In the second embodiment of the present invention, the web-based user interface is implemented by a program manager execution layer, a system program execution layer, a remote program manager package and a market server. Meanwhile, in the second embodiment of the present invention, the web-based user interface further includes a synchronization server for enabling various setup information set in a communication terminal and setup information managed for each user by a program manager market server are synchronized in real time.

FIG. 1 illustrates an overall module configuration and an interworking relationship of the apparatus for implementing a web-based user interface according to the first embodiment of the present invention. In FIG. 1, shaded areas indicate modules constituting the present invention and dotted areas indicate modules of a program server 3 capable of being temporarily cached in a communication terminal 1.

The communication terminal 1 is a communication terminal connected to a data communication network, and includes a dedicated OS or a general-purpose OS 11. The communication terminal 1 is a terminal capable of executing a web browser module. Most mobile communication terminals may be used as the communication terminal 1. Alternatively, some wired communication terminals may be used as the communication terminal 1.

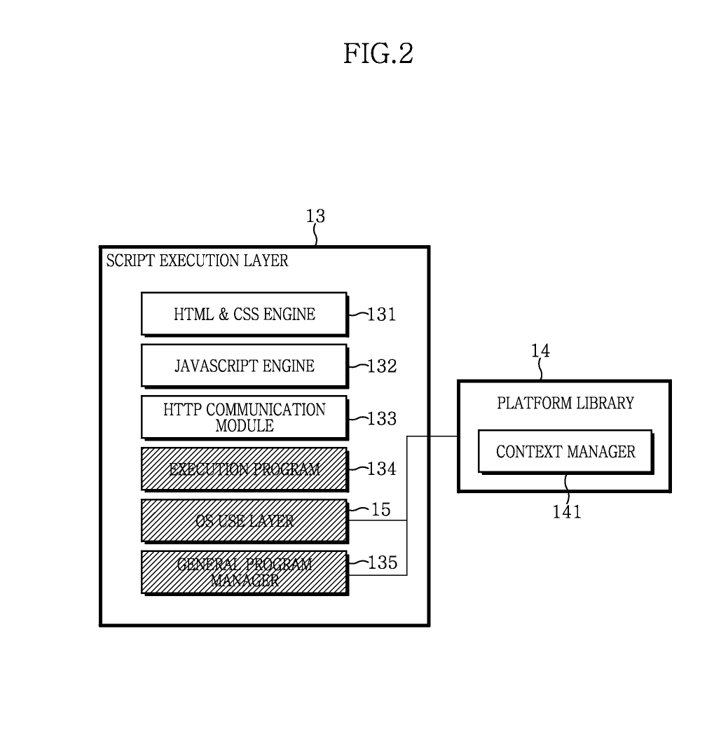

A script execution layer 13 is responsible for communication and execution of scripts. HTML, CSS and JavaScript have been developed to be used as a current general-purpose technique standard. Since the communication uses HTTP, the script execution layer 13 includes a standard web browser core module. Accordingly, the script execution layer 13 has a function of receiving a script program 32 from the program server 3 and executing the script program 32 together with a platform library 14. In addition, the script execution layer 13 further includes an OS use layer 15 in order to use a function of a terminal OS 11, and a module for managing a general binary program 12. This will be described in detail with reference to FIG. 2.

The platform library 14 is a JavaScript library for providing a function of enabling a script program to operate at a level of a general program. The platform library 14 includes the following library modules.

Graphic user UX module: A module for providing functions such as a window, a menu, a list, a button, an image album, and input control for provision of a GUI.

Screen rearrangement engine: An engine for rearranging a user interface on a screen in consideration of a difference between a variety of screen standards for a terminal.

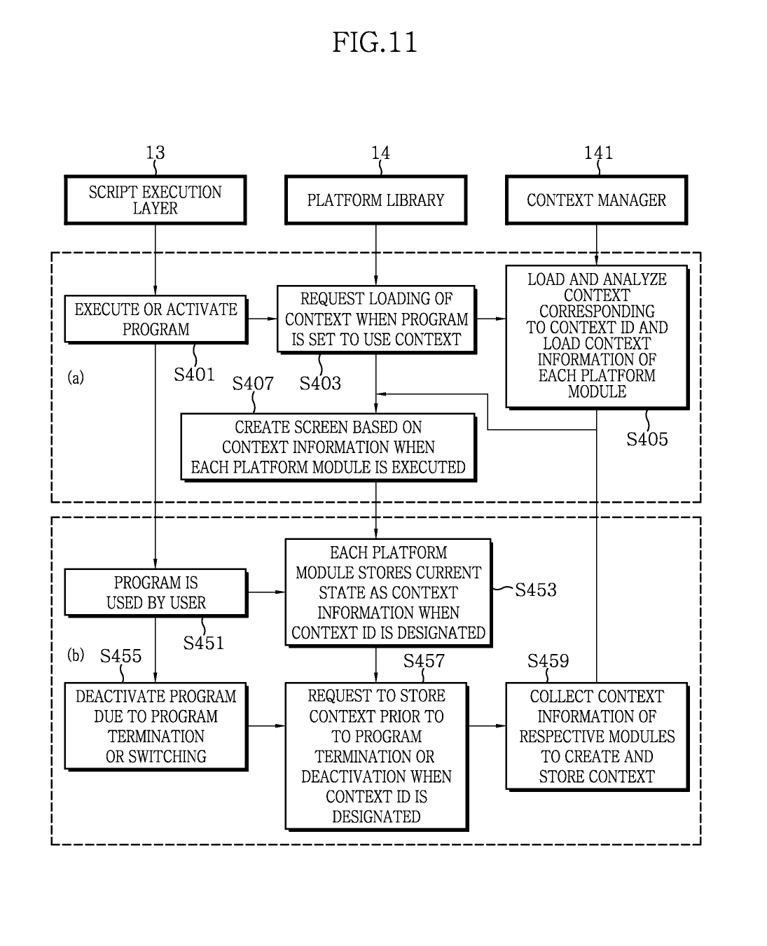

Context manager: A module for storing an execution state of each script program 32 and managing program start and restart information. This will be described in greater detail with reference to FIG. 11.

Terminal engine compatible layer: A layer for overcoming a function and standard difference between terminals and a standard difference between browser engines and providing the same system interface.

Communication module: A module for providing server/client communication in a variety of manners

Data storage/management: A module for storing and fetching data in and from the terminal and the server

Dynamic module management: A module for dynamically installing and managing programs or libraries

Animation/effect: A module for providing various animations and effects

Accordingly, the platform library 14 is used to develop a script program. This script program provides a user interface and a function at a level of a general binary program. Further, the program manager 33 of the present invention is a script program developed using the platform library 14.

The OS use layer 15 is a module for providing an interface that provides, in the platform library 14, a terminal system function, i.e., telephone, SMS service, data transmission, shared file access, personal data access, system setup and the like. The OS use layer 15 is provided in the script execution layer 13 through JavaScript. The OS use layer 15 may be implemented in two manners: a manner in which the OS use layer 15 is installed in an extension module form of the script execution layer 13 and included in the script execution layer 13, and a manner in which the OS use layer 15 is separated as an external module according to the terminal OS 11 and is called by a JavaScript engine of the script execution layer 13.

In a technical aspect, the program server 3 is a form of a web server, and includes a script program 32, various server programs and a related database for configuring the user interface of the communication terminal 1. The program server 3 interworks with a communication provider portal server 5 to implement the user terminal interface as a portal.

The script program 32 is defined in the present invention as a term referring to a site consisting of HTML, CSS and JavaScript. In a broad sense, the script program 32 may include an HTML site consisting of only HTML. Generally, the script program 32 refers to an application consisting of HTML, CSS and JavaScript and using the platform library 14. The program server 3 stores the script program 32 in two ways: a manner in which the script program 32 is managed in the form of HTML, CSS and JavaScript files and a manner in which only URLs for calling files are managed. The program manager 33 additionally manages additional information such as icons, locations, titles, explanations, categories, and classes of programs for the sake of the user interface.

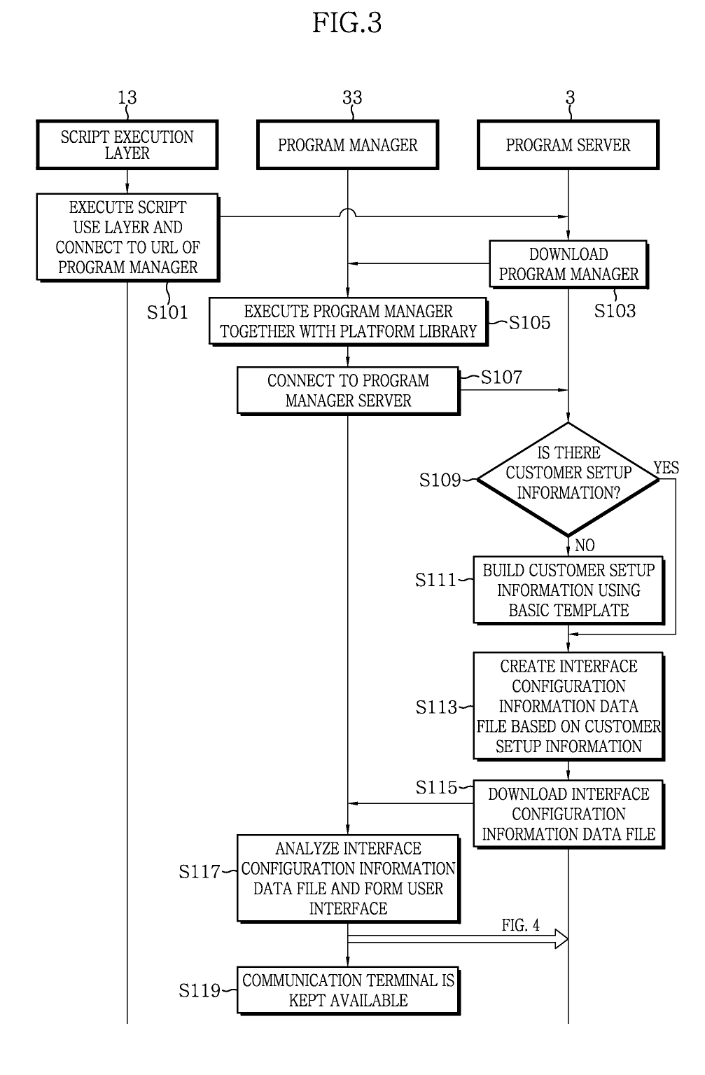

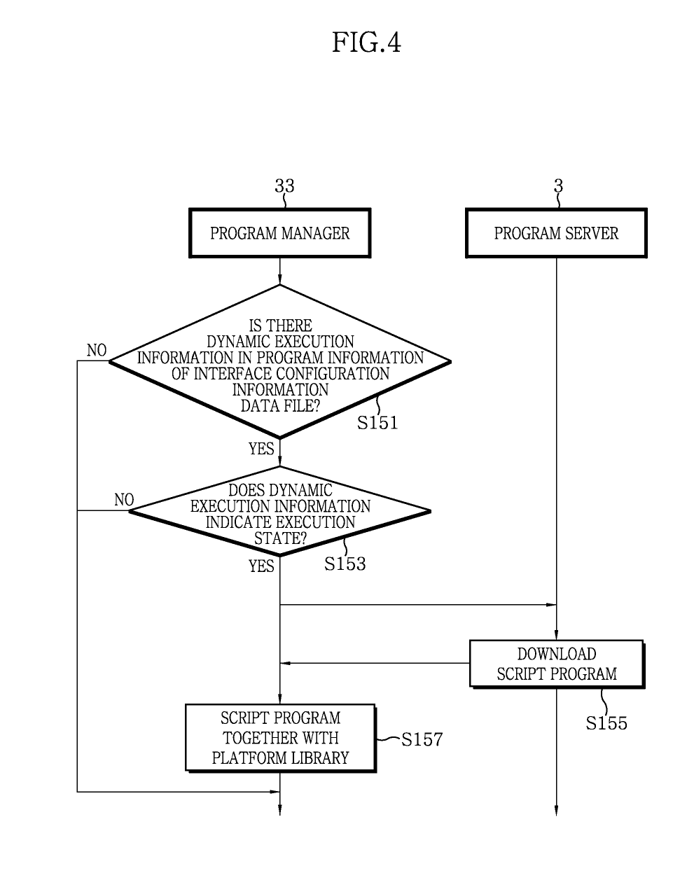

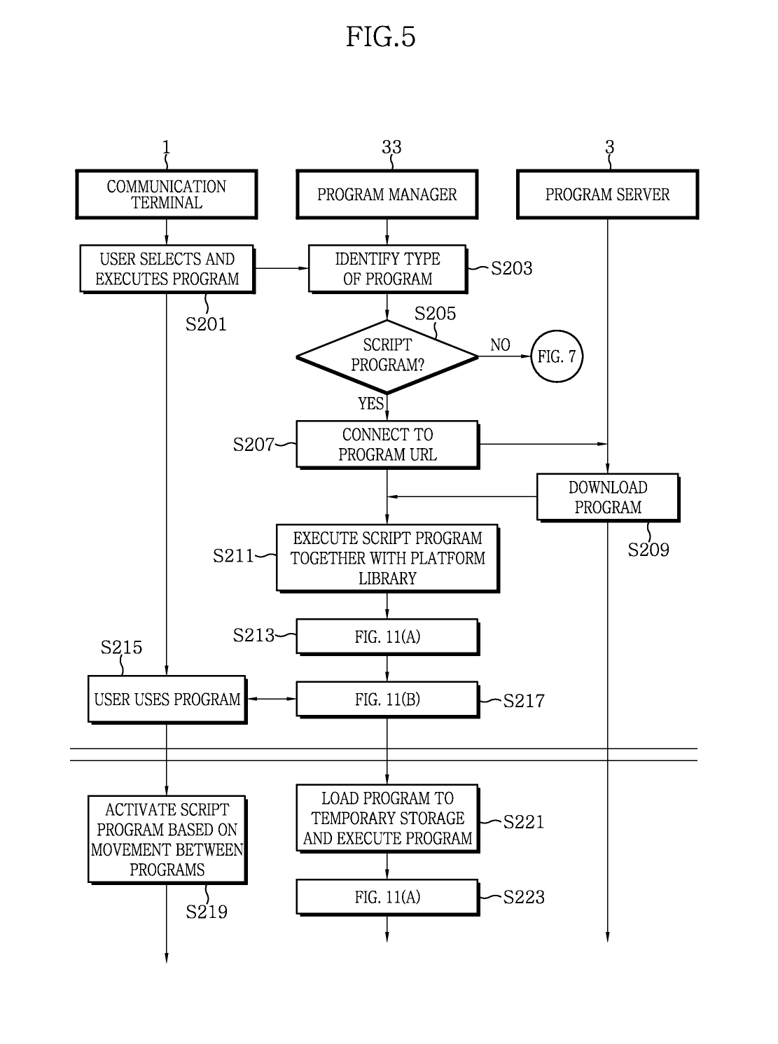

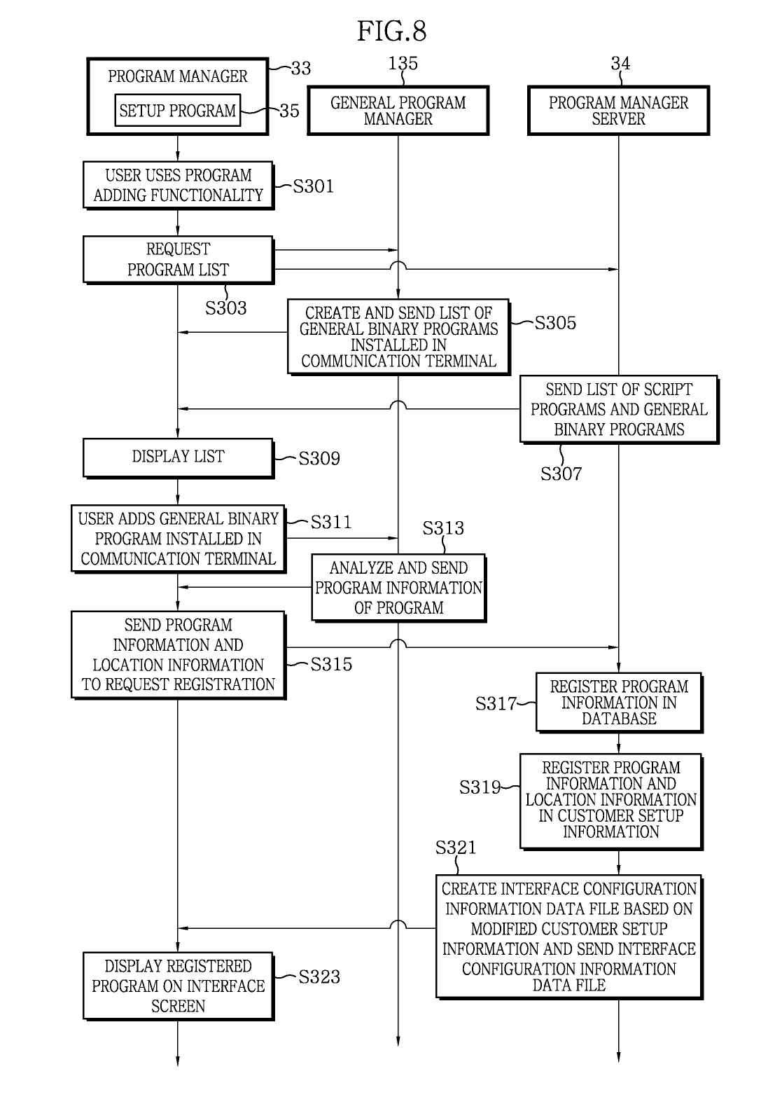

The program manager 33 is one script program for providing a terminal user interface. When the communication terminal 1 is started up and the script execution layer 13 is executed, an initial URL indicates the program manager 33 and accordingly the program manager 33 is executed. When the program manager 33 is executed, the program manager 33 accesses a program manager server 34 of the program server 3 and receives an interface configuration information data file. The program manager 33 analyzes information of the data file and displays a menu, a program icon, terminal information, and screen configuration to complete the terminal interface. The program manager 33 may manage both the script program 32 and the general binary program 36 and provides dynamic execution of the script program 32. This procedure will be described in detail with reference to FIGS. 3 and 4. Further, the program manager 33 provides a function of executing a program by a selection of a user (FIGS. 5, 6 and 7) and a function of enabling the user to add a new program or set a menu (FIGS. 8, 9 and 10).

The program manager server 34 creates and sends the user terminal interface configuration information to the program manager 33, and provides a function of adding, modifying and deleting user terminal interface configuration information in response to a request from the program manager 33. The program manager server 34 is a web server program. The program manager server 34 manages/analyzes a database for template information 341, customer setup information 342, and portal service information 343, creates the interface configuration information data file and provides the interface configuration information data file to the program manager 33. A screen structure, a display style, a menu configuration and location, program information and location, portal recommended program information and the like are included in the interface configuration information data file.

A setup program 35 is a script program. The setup program 35 provides a screen for a user interface setting function. That is, the setup program 35 provides functions of adding, deleting and setting programs, setting screen styles, and setting menus. When the program manager 33 selects the setting function, the program manager 33 switches to a URL of the setup program 35 so that the setup program 35 is executed. When the setup program 35 sends setup data by interworking with the program manager server 34, the program manager server 34 stores information modified by the user in the database.

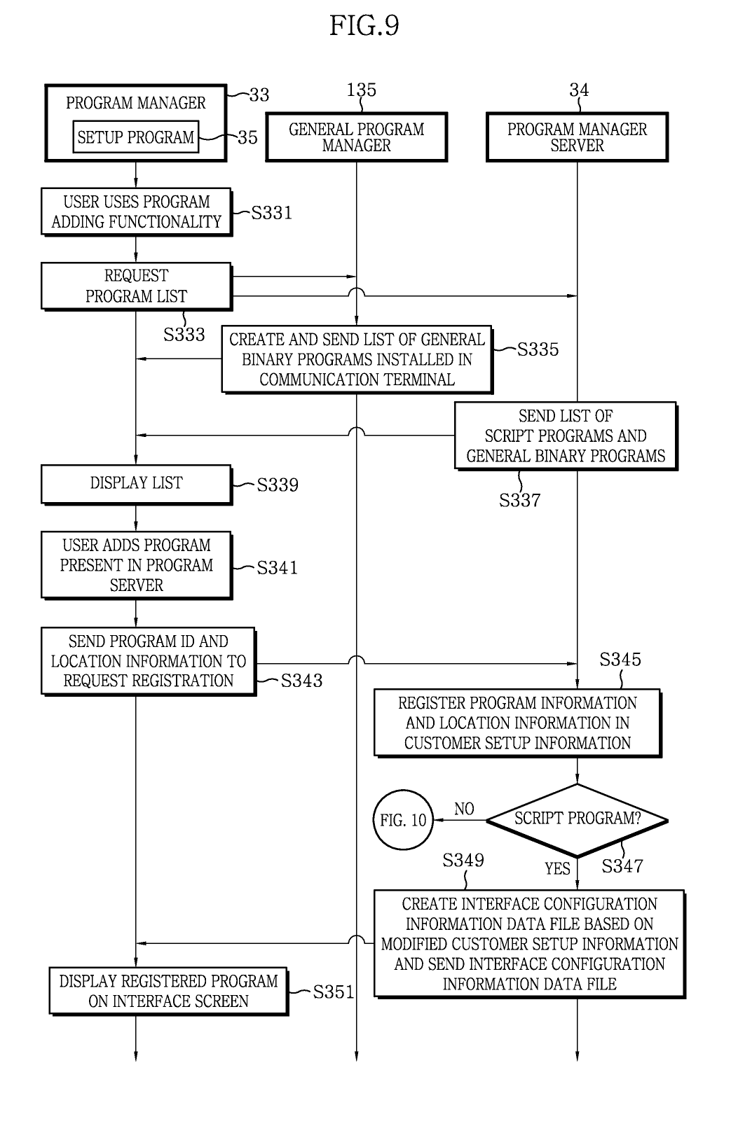

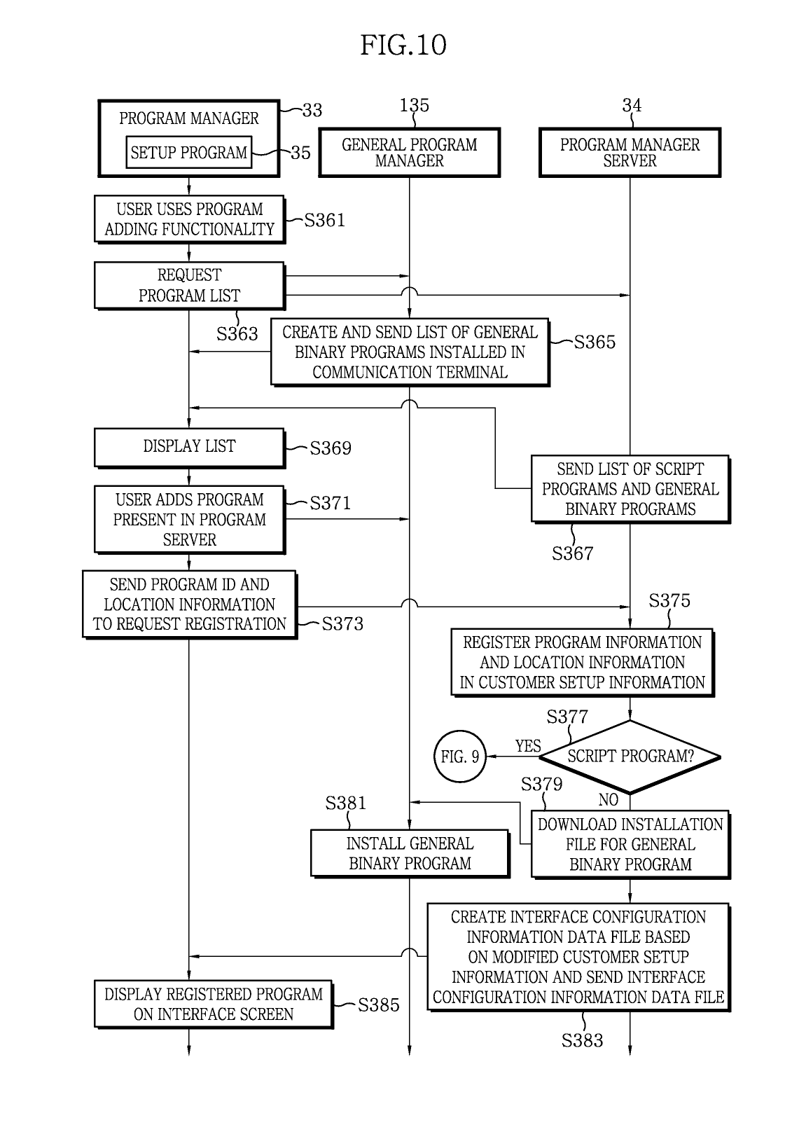

General binary programs 12 and 36 refer to general programs operating in a binary form in the terminal OS 11. The general binary programs 12 and 36 may be installed in the communication terminal 1 by the user and registered in the program manager 33 or may be downloaded and registered from the program server 3 to the communication terminal 1 via the program manager 33. This procedure is for providing a single user interface, by the program manager 33 managing the general binary programs 12 and 36 together. A registration procedure in the communication terminal 1 is described in FIG. 8 and a registration procedure in the program server 3 is described in FIGS. 9 and 10.

The system script refers to a script program for providing primary terminal system functions such as calling, SMS message transmission, and personal information management, among script programs. The program server 3 provides a system script server 37 for such a program. The system script server 37 provides a function of enabling the system scripts to store customer information 371 in synchronization in the server, so that the user can use a user information backup function, access the program server 3 via the Internet 7 to inquiry personal information while watching its own terminal user screen, and use some communication functions. This function is realized by being implemented by a standard web technique in the present invention and indicated by an interface c in FIG. 1.

In the present invention, information on a terminal configuration screen, icons, colors, images, video, sound, and program configuration for a user interface configuration of the terminal is defined as template information 341 and a variety of templates are provided. In the present invention, templates can be provided without restriction and a new template can be continuously provided. Further, the function of the program manager 33 and the template function can be enhanced.

In the present invention, a user interface configuration screen of the terminal for all users is stored as the customer setup information 342 in the program server 3. In the customer setup information 342, user screen configuration, menu structure, use program icon and location, color, sound and image information and the like are included. In the present invention, this function enables a user holding a new terminal to view the same user interface on the new terminal and to view the terminal screen through the Internet.

The portal service information 343 is information related to a portal server interface b. The communication provider portal server 5 can provide portal services to the script program 32 by interworking the program server 3, and provides a function of recommending/displaying the portal service on the user terminal screen via the program manager 33. Accordingly, the communication provider is allowed to create a user interface for a new terminal that is a combination of its own portal service and the terminal user interface. The portal service information 343 is information planned and provided by a portal site in order to recommend/display the portal service on the terminal user interface. In order for programs in the portal site to have a user interface at the same level, the program must consist of the platform library 14 of the present invention.

Communication interface a: For interworking between the communication terminal 1 and the program server 3, the script execution layer 13 of the communication terminal 1 and the web server 31 of the program server 3 interwork using standard HTTP protocol.

Portal server interface b: The communication provider portal server 5 registers each service site of a portal in the program server 3 using a script program so that the portal services are displayed/configured together on the user interface of the communication terminal 1. Further, script programs recommended according to planning of the communication provider portal server 5 may be registered in the portal service information 343. Accordingly, recommended services or new services are dynamically displayed on the user terminal interface. The portal server interface b is an interface for such interworking.

Internet interface c: Interface for enabling access to the program server 3 via the Internet 7. Since the platform library 14 of the present invention equally operates even in a web browser of a PC, when the program manager 33 is started up on the PC, the user can view the same user communication terminal screen and inquire/modify user terminal information through the system script, and interwork with calling and SMS services via the Internet 7.

FIG. 2 illustrates a structure of the script execution layer 13. The script execution layer 13 includes an HTML & CSS engine 131 that is a general web browser core module, a JavaScript engine 132, and an HTTP communication module 133. For the sake of the present invention, the script execution layer 13 further includes the following three modules: an execution program 134, an OS use layer 15, and a general program manager 135.

The execution program 134 is a program that actually drives other modules of the script execution layer 13. In order to operate as a user interface, the execution program 134 is a program developed to operate as a user program manager or a background screen program in the terminal OS 11. The execution program 134 is developed in a different manner between OSs.

The OS use layer 15 has been described in FIG. 1, and thus an overlapping description will be omitted.

The general program manager 135 is a module for managing a process of the general binary program 12. That is, the general program manager 135 provides a function of starting up, managing and terminating programs of the terminal OS to provide the same user interface between the script program and the general binary program.

The context manager 141 of the platform library 14 is a module for storing and managing execution information in relation to start and restart of script program using a similar function to the general program manager 135. This module manages a context (execution information) of the script program. When the script program is restarted, the module reads previous context so that an execution state is restored.

FIG. 3 illustrates a procedure of outputting a user interface screen to a display of the communication terminal 1 when the communication terminal 1 is started up.

When the communication terminal 1 is started up, the script execution layer 13 is first executed by an OS function. When the script execution layer 13 is executed, the script execution layer 13 connects to a URL of the program manager 33 by means of setup (S101). Then, the sources, i.e., HTML, CSS and JavaScript (and other images, moving images and the like) of the program manager 33 are downloaded from the program server 3 to the communication terminal 1 (S103). In this case, when the sources of the program manager 33 have not been changed, sources stored in the communication terminal 1 in advance may be used instead of the sources being downloaded using a general caching function.

The program manager 33 is executed together with the platform library 14 by an HTML or JavaScript source (S105). When the program manager 33 is started up, the program manager 33 connects to the program manager server 34 by means of the setup (S107) (in this case, the caching function as described in S103 is available).

When there is no customer setup information (that is, when the user is an initial accessing person) (S109), the program manager server 34 configures customer setup information using a basic template (S111). Screen setup of this basic template is based on a user interface structure designed by the communication provider and includes services added by the portal service. Then, the program manager server 34 configures customer setup information as a data file that can be analyzed by the program manager 33 (interface configuration information data file) and downloads the data file to the communication terminal 1 (S113 and S115).

The program manager 33 analyzes the data file and implements the user interface on the terminal screen. That is, a screen division structure, program icons, menu structure and information, system information, screen style images, moving images, and the like are displayed on the screen (S117). In this case, the program manager 33 of the present invention provides a function of displaying an icon of a program, as well as a function of executing the script program 32 and displaying the execution result on the screen. For a script program using such functions, dynamic execution information is included in the data file. Accordingly, when there is dynamic execution information, a corresponding script program may be dynamically downloaded and executed in a user background screen. This procedure will be described with reference to FIG. 4. Then, the communication terminal 1 is kept available (S119).

FIG. 4 illustrates a function of dynamically executing the script program 32 in the user interface screen, and is part of step S117 in FIG. 3.

When the terminal user screen has been configured and the dynamic execution information is included in the program execution information described in the data file, the program is capable of being “dynamically executed.” Accordingly, the program manager 33 analyzes the dynamic execution information (S151). The dynamic execution information includes a program URL, program creation and execution information, a screen display location, a size, an execution period, and execution state (execution/stop) information.

In the present invention, such programs are not downloaded in advance and a judgment is not made as to whether the program is to be executed, but only programs to be executed are displayed on the terminal user screen and then downloaded and executed. This is for rapidly configuring an initial terminal screen.

When the execution state is displayed as “executed” (S153), the program manager 33 connects to the program URL and downloads the script program 32 from the program server 3 (S155), and creates and executes the program based on “program creation and execution information” (S157). The program manager 33 outputs the execution program according to the “size” at the “screen display location.” When there is “execution period” information, the program manager 33 periodically executes the program even while the program is being displayed on the terminal screen.

FIGS. 5 to 7 illustrate a procedure in which the user executes a program in the user interface screen, i.e., the program manager 33 and a manner in which a program is managed. In the present invention, the user is allowed to execute the script program 32 and the general binary program 12 without discriminating the programs from each other.

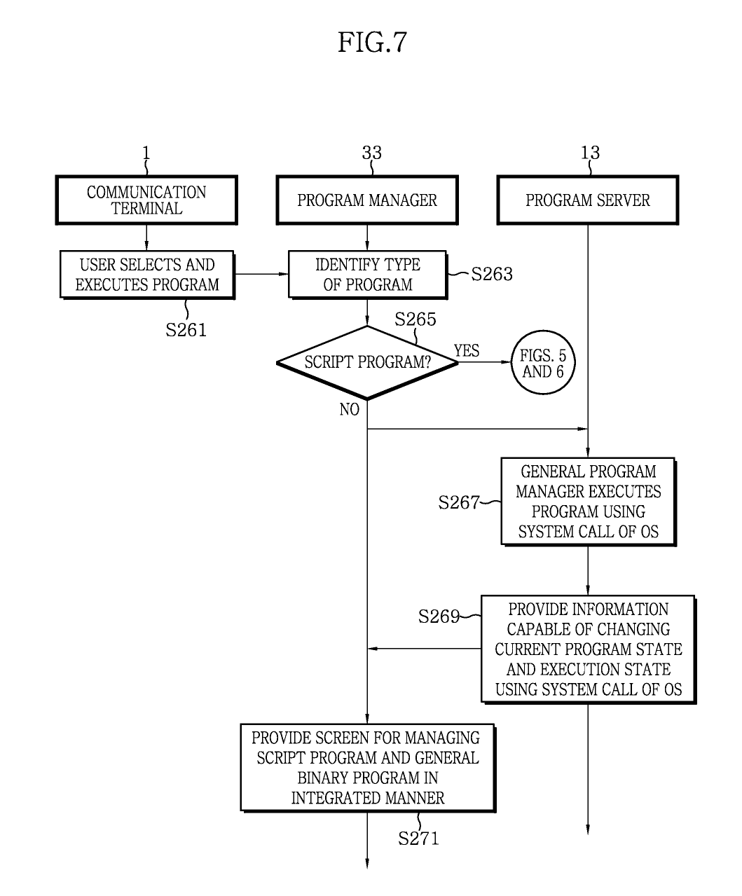

First, FIG. 5 illustrates a script program execution procedure. In the communication terminal 1, when the user selects and executes a program (S201), the program manager 33 identifies a type of the program based on link information of the program (S203). When the program type indicates a script program, S207 and subsequent steps are executed, and otherwise, the process of FIG. 7 is executed (S205).

The program manager 33 connects to the program URL and downloads the script program 32 of the program server 3 (in this case, the general caching function is available) (S207 and S209). The program URL indicates the program of the program server 3, and resources constituting the program, such as HTML, CSS, JavaScript, images, and moving images, are downloaded. Then, the downloaded HTML of the script program is loaded and executed together with the platform library 14 (S211).

The platform library 14 provides a context management function so that a plurality of script programs 32 can be executed with one script execution layer 13. When the context is loaded directly after the script program execution, the program is kept in a previous execution termination state and executed (S213). This step will be described in greater detail in FIG. 11(a).

Then, the user may use the script program 32, like a general program (S215). A change in the screen and data as a result of the user execution is stored in the context. This step will be described in greater detail with reference to FIG. 11(b) (S217).

When a program that has been deactivated is activated due to program switching by the user, a script program stored in a temporary storage (cache) of the communication terminal 1 is immediately loaded and executed (S219 and S221). Following the program execution, a previous screen state is restored by the context management (S223). This step corresponds to FIG. 11(a).

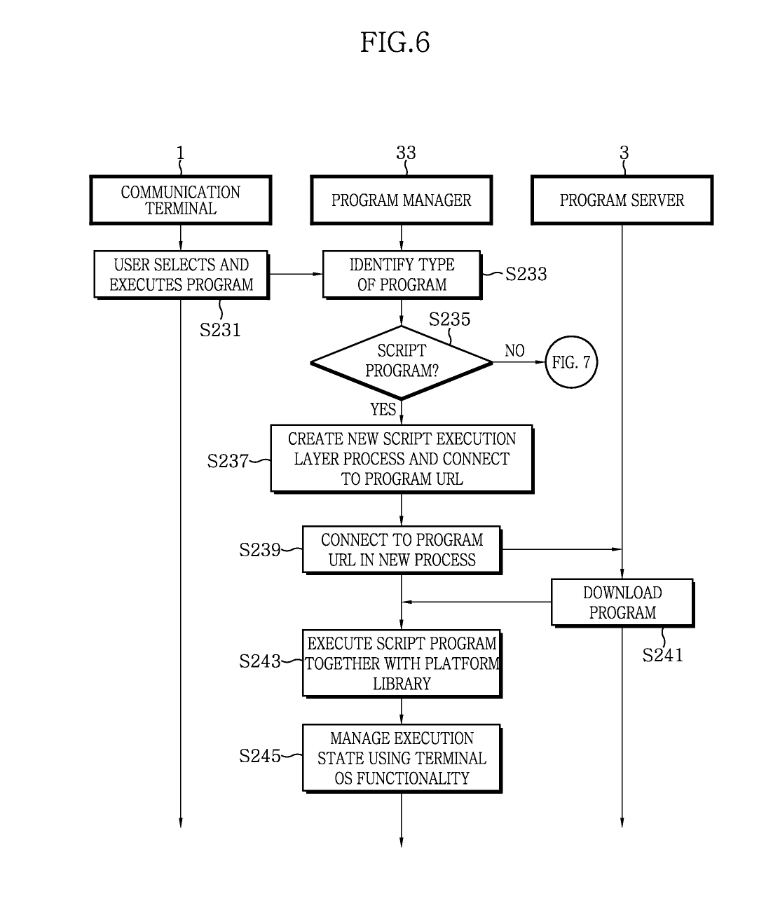

FIG. 6 illustrates a manner in which a program management policy of a terminal OS is utilized as it is in order to simultaneously execute several script programs, with the purpose as in FIG. 5.

In the communication terminal 1, when the user selects and executes a program (S231), the program manager 33 identifies the type of the program based on the link information of the program (S233). When the program type indicates a script program, the program manager 33 executes step S237 and subsequent steps, and otherwise executes the process of FIG. 7 (S235).

A new script execution layer process is executed in order to execute the script program 32. That is, the new script execution layer process is created separately from the script execution layer executing the program manager 33, and a program URL is delivered to the new process (S237).

The new script execution layer process connects to the program URL and downloads the script program 32 of the program server 3 (in this case, the general caching function is available) (S239 and S241). The program URL indicates the program in the program server 3, and resources such as HTML, CSS, JavaScript, images, moving images, and the like, which constitute the program, are downloaded. Then, the HTML of the downloaded script program is loaded, and executed together with the platform library 14 (S243).

In this case, an execution state and a context of the new script execution layer process are managed by the management policy of the terminal OS 11.

FIG. 7 illustrates a procedure in which the program manager 33 executes the general binary program 12.

In the communication terminal 1, when the user selects and executes a program (S261), the program manager 33 identifies the type of the program based on link information of the program (S263). When the program type indicates a script program, the program manager 33 executes the process of FIG. 5 or 6, and otherwise executes step S267 and subsequent steps (S265).

The general program manager 135 included in the script execution layer 13 executes the program using the function of the terminal OS 11 (S267). In this case, the general program manager 135 executes the program using an execution path or a unique ID of the program. An execution state of the general binary program 12 is managed by the policy of the terminal OS 11. The general program manager 135 provides the program execution state to the program manager 33 using system call of the terminal OS 11 so that the program manager 33 displays the general binary program and the script program without discrimination. Further, the general program manager 135 provides a function of changing a state, such as program termination, to the program manager 33 so that the program manager 33 changes the program state (S269). Accordingly, the program manager 33 can provide a screen for enabling the execution state and the state change of the script program and the general binary program to be managed in an integrated manner (S271).

FIGS. 8 to 10 illustrate a procedure in which a new program is added to the user interface screen via the program manager 33.

FIG. 8 illustrates a procedure in which the general binary program 12 installed in the communication terminal 1 by the user via the program manager 33 is added to the user interface screen.

The user executes the setup program 35 via the program manager 33 in order to add a program to the user interface (S301). The setup program 35 is a script program.

The setup program 35 calls the general program manager 135 of the script execution layer 13 to find a list of general programs installed in the terminal by the user, and accesses the program manager server 34 of the program server 3 to receive and display a list of script programs and general binary programs available to the user (S303, S305, S307 and S309).

When the user selects and adds a general binary program installed in the communication terminal 1 (S311), the setup program 35 calls the general program manager 135 of the script execution layer 13 to receive program information of the general binary program (S313). Here, the program information is information related to a path or unique ID, an icon, and an execution environment of the program.

The setup program 35 sends both the received program information and information on a screen location at which the program is to be added, to the program manager server 34 to request program registration (S315). In response thereto, the program manager server 34 registers program information of the general binary program in the database (S317), and registers the program information and the location information in the customer setup information 342 (S319).

When the program manager server 34 creates an interface configuration information data file based on modified customer setup information 342 and sends the interface configuration information data file to the program manager 33 (S321), the program manager 33 adds an execution icon for the registered program to the screen location selected by the user and displays the execution icon (S323).

FIG. 9 illustrates a procedure in which the script program 32 among programs in the program server 3 is added to the user interface screen.

The user executes the setup program 35 via the program manager 33 in order to add a program to the user interface (S331). The setup program 35 is a script program.

The setup program 35 calls the general program manager 135 of the script execution layer 13 to find a list of general programs installed in the terminal by the user, and accesses the program manager server 34 of the program server 3 to receive and display a list of script programs and general binary programs available to the user (S333, S335, S337, and S339).

When the user selects and adds a program present in the program server 3 (S341), the setup program 35 sends both a program ID and information on a location at which the program is to be added, to the program manager server 34 to request program registration (S343). The program manager server 34 registers the program information and the location information in the customer setup information 342 (S345). When the registered program is a script program, step S349 and subsequent steps are performed, and otherwise, the process in FIG. 10 is performed (S347). When the program manager server 34 creates an interface configuration information data file based on the modified customer setup information 342 and sends the interface configuration information data file to the program manager 33 (S349), the program manager 33 adds an execution icon for the registered program to the screen location selected by the user and displays the execution icon (S351).

FIG. 10 illustrates a procedure in which the general binary program 36 among programs in the program server 3 is added to the user interface screen.

The user executes the setup program 35 via the program manager 33 in order to add a program to the user interface (S361). The setup program 35 is a script program.

The setup program 35 calls the general program manager 135 of the script execution layer 13 to find a list of general programs installed in the terminal by the user, and accesses the program manager server 34 of the program server 3 to receive and display a list of script programs and general binary programs available to the user (S363, S365, S367, and S369).

When the user selects and adds a program present in the program server 3 (S371), the setup program 35 sends both a program ID and information on a location in which the program is to be added, to the program manager server 34 to request program registration (S373). The program manager server 34 registers the program information and the location information in the customer setup information 342 (S375). When the registered program is a script program, the process in FIG. 9 is performed, and otherwise, a subsequent process is performed (S377). The program manager server 34 downloads an installation file for the registered general binary program to the communication terminal 1 (S379), and the general program manager 135 of the communication terminal 1 executes the downloaded program installation file and installs the registered general binary program in the communication terminal 1 (S381).

Then, when the program manager server 34 creates an interface configuration information data file based on the modified customer setup information 342 and sends the interface configuration information data file to the program manager 33 (S383), the program manager 33 adds an execution icon for the registered program to the screen location selected by the user and displays the execution icon (S385).

Meanwhile, in the present invention, a function of enabling the user to delete a program on the user interface screen is naturally provided. When the program manager 33 deletes a program icon, deleted program information is sent to the program manager server 34, and the program is deleted from the customer setup information 342. The program manager 33 deletes an icon or a menu of the program from the user interface screen.

Further, in the present invention, a function of changing a display attribute and form of a user interface screen, as well as programs is also provided. That is, this is for setting the structure, color, image, button, moving image and sound information of the screen. In the present invention, since the program manager 33 is a script program, such modified information is all sent to and stored in the program server 3.

FIG. 11 illustrates the context management function of the platform library 14 described in the execution procedure in FIG. 5 of the present invention. The context refers to a current execution state of a program. In the present invention, the context is a context of the script program. Accordingly, the context is not a function capable of being provided by the terminal OS 11 or the script execution layer 13, but can be implemented when each user UX module of the platform library 14 provides a context storage function.

When the script program needs to have a context management function, context use and context ID information is set in a program source. When this information is set, all user UX modules of the platform library 14 activate a context storage function.

(a) of FIG. 11 illustrates a procedure of loading a context and restoring a program execution state.

When the program is executed or activated (S401) and the script program is set to use a context, the platform library 14 delivers a context ID to the context manager 141, which is its module, to request loading of the context (S403).

When there is a context stored with the context ID, the context manager 141 loads and analyzes the context and loads context information capable of being interpreted by each user UX module of the platform library 14, to the memory (S405). When the program is executed and displayed, each user UX module constituting the program creates and displays a screen based on context information of the module (S407). Accordingly, a previous execution state of the program is restored.

(b) of FIG. 11 illustrates a procedure in which current state information of an execution screen is stored in the context while the script program is being executed.

When a program is used by a user (S451) and a context ID is designated in the program, each user UX module of the platform library 14 stores a current state as context information in the memory through a context management function (S453).

When the program is deactivated by program termination or switching (S455) and a context ID of the program is designated, the platform library 14 requests the context manager 141 to store a context prior to program termination or deactivation (S457). Then, the context manager 141 collects context information of the respective modules of the platform library 14 to create and store the context (S459).

The “script execution layer” of the present invention may be started up and executed in a different manner from terminal OS to terminal OS. Execution of the function described in the present invention may be considered to be a variant of the present invention whether a method of starting up this binary program and replacing the terminal user interface is a formally OS-provided method or a privately developed method.

In the present invention, a manner of developing the “OS use layer” may differ according to the terminal OS and core modules of a used web browser. That is, plug-in SW may be installed in the web browser or the “script execution layer” may provide the function while controlling the “web browser core module” in an upper layer. Alternatively, the function may be provided by installing a separate external module and requesting the module to provide the function. All the developing manners belong to variants of the present invention.

In the present invention, a “communication provider portal” does not necessarily refer only to a “portal service” of a “communication provider,” but may refer to influential general portal providers. That is, a platform terminal of the present invention may also be applied to an Internet provider such as a general portal provider and a game provider according to a degree of openness of the OS.

Advertisement business conducted by configuring this template with a subject related to advertisement in relation to a user selecting and using the “template information” described in FIG. 1 of the present invention (i.e., a user interface screen defined with a specific subject and design style in advance, i.e., an information group of a “screen structure,” an “image,” a “dynamic script program executed in a background screen,” “system script,” “moving image,” “sound” and the like) belongs to the present invention. In particular, when the present invention is applied to this business, the present invention can be directly applied without replacement of system modules in the terminal OS when the user replaces the template, such that the present invention can be applied by the user with no burden. A “script program” is dynamically displayed on the background screen, such that dynamically changed related information can be displayed.

The apparatus and method according to the first embodiment of the present invention have been described. Next, the apparatus for implementing a web-based user interface for a communication terminal and the method thereof according to the second embodiment of the present invention will be described with reference to FIGS. 12 to 23.

In the first embodiment of the present invention, the script execution layer, the platform library, the program manager and the program manager server are used as a basic configuration to implement the web-based user interface, as described above. In the second embodiment of the present invention, which will be described later, a program manager execution layer, a system program execution layer, a remote program manager package and a market server are used as a basic configuration to implement the web-based user interface. Meanwhile, in the second embodiment of the present invention, a synchronization server is further included to synchronize, in real time, various setup information set in the communication terminal and setup information managed for each user by the program manager market server.

FIG. 12 illustrates an interworking relationship of an overall module configuration according to the second embodiment of the present invention. For implementation of the present invention, the following systems and modules may be used (in this case, in FIG. 12, “shaded areas” indicate the modules of the present invention and “dotted areas” indicate modules implemented and operated by JavaScript. Meanwhile, a detailed description of modules having the same name and function as those in the first embodiment described above will be omitted.

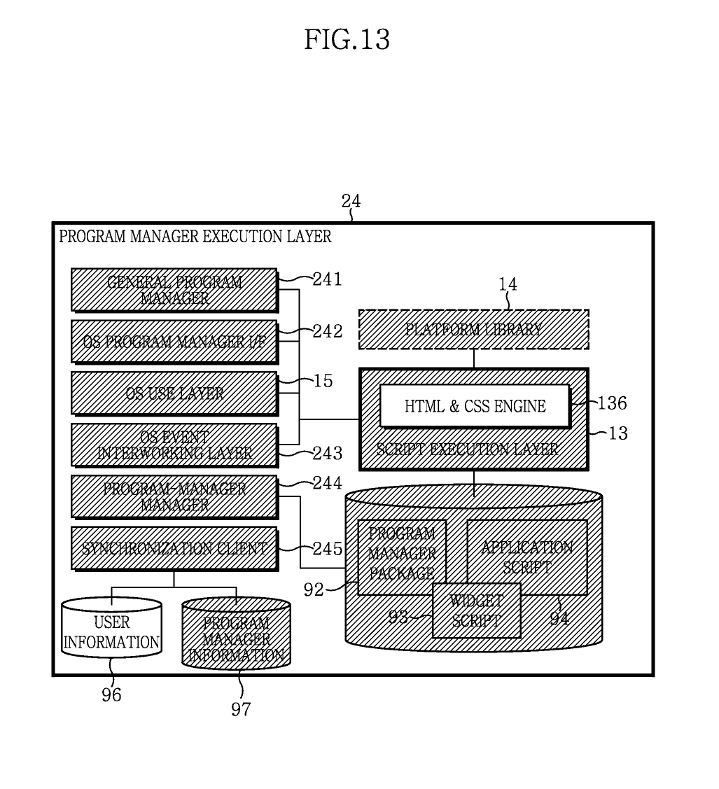

Program manager execution layer 24: This SW layer is responsible for use of the OS function and execution of a “script.” The present invention has been implemented to use HTML, CSS and JavaScript, which are general-purpose technique standards, and the communication uses HTTP, such that the program manager execution layer 24 includes a “standard web browser core module.” Further, the program manager execution layer 24 has a general binary program management function, a function of using the OS function and interworking an event with the OS, and a function of operating as a program manager of the OS. The program manager execution layer 24 supports a function of managing and executing an installed “program manager script,” “system script” and “application & widget script.” A detailed description thereof will be given later in the description of FIG. 13.

Script and setup storage 23: The present invention has an advantage in that a user is allowed to simultaneously use multiple user interfaces. The script and setup storage 23 is a database for managing several user interface programs (i.e., “program manager” scripts) and managing execution information and setup information of each “program manager.” Further, the script and setup storage 23 stores and manages “application scripts” and “widget scripts” downloaded from a “program manager market server.”

Animations/effects: A module for providing various animations and effects

Thus, according to the second embodiment of the present invention, a “script program” is developed using the platform library 14 and provides a user interface and a function at a level of the “general binary program.”

Program manager library 21: A JavaScript library that provides an icon management screen, a menu screen, a widget screen, APP installation and management, a system management menu and OS interworking functions for implementing the communication terminal user interface. The library operates on the platform library 14 and the OS use layer 15 and provides all necessary modules for developing the program manager script 20, and thus, an external developer can easily develop the program manager script 20 to develop a variety of screens of the communication terminal 1 using such modules.

OS use layer 15: A module for providing an interface for providing a terminal system function in the platform library 14, i.e., an application management function, a widget management function, and a function for OS event notification, telephone/SMS service, data transmission, shared file access, personal data access, system setup and the like. The function of this module is used by the “script program” executed in the script execution layer 13. When a necessary function is called, the script execution layer 13 requests the OS use layer 15 to perform execution and provides the result to the “script program.”

System program execution layer 22: This SW layer has a similar function to the program manager execution layer 24, but is a layer for executing the “script program.” Thus, the system program execution layer 22 is for executing a function of a system program executing a specific system function. The SW layer provides a function of enabling a program developed by a script to operate as a specific system program. This program is separate from the program manager execution layer 24 because respective system functions must be executed through a separate process according to OSs. The function of the system program of the present invention includes functions of a screen lock program, a calling program, an SMS message program, a search program and the like. That is, when a “system script” having a screen lock program function is executed in the system program execution layer 24, a web-based “system script” operates as a screen lock program of the OS.

System script 19: A program developed by HTML, CSS and JavaScript. This program calls system functions supported by the system program execution layer 22 and operates as a system program for each function. In the present invention, the program includes a screen lock program, a calling program, an SMS message program, a search program, and the like. Accordingly, a user can easily replace a system program and access terminal information via a WEB by means of data synchronization.

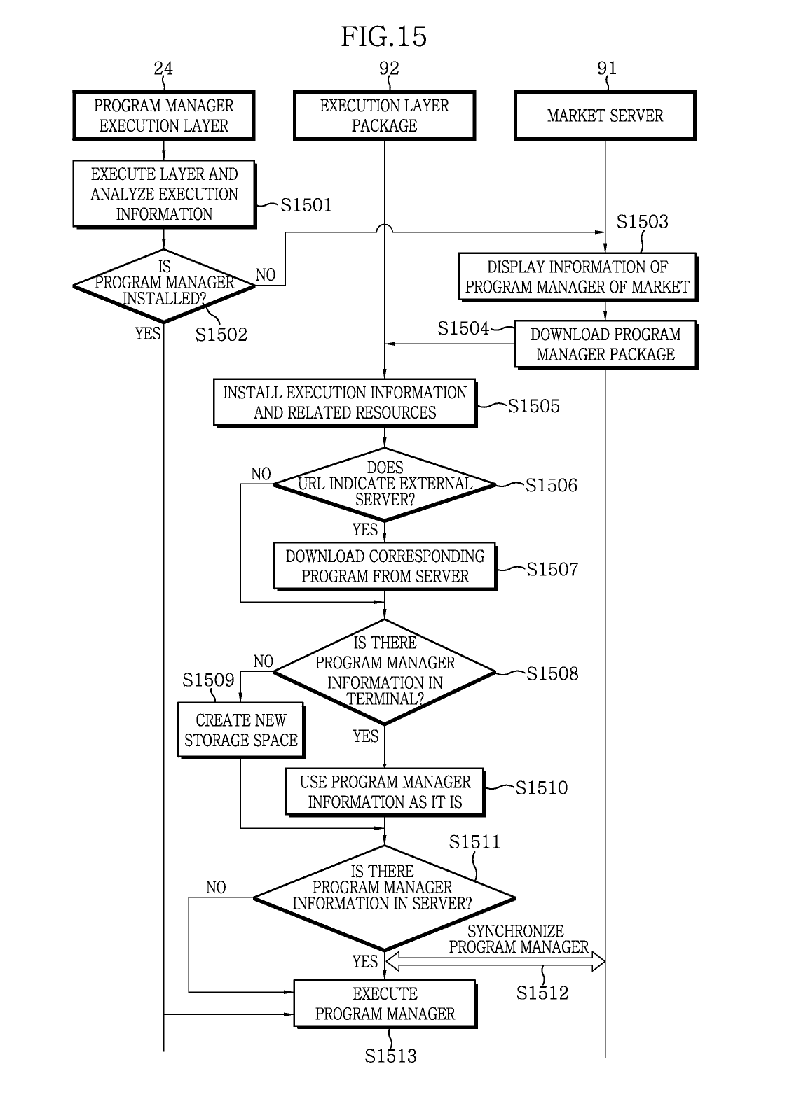

Program manager script 20: A script program for providing a terminal user interface. When the terminal is started up and the program manager execution layer 24 is executed, an initial connection URL of this layer corresponds to the program manager script 20. Accordingly, the program manager script 20 is executed. When information of the program manager script 20 registered in the script and setup storage 23 is an internal URL of the terminal, the program manager script 20 is executed in the terminal. When the information of the program manager script 20 registered in the script and setup storage 23 is an external URL, source code is downloaded from an external server, i.e., the program manager market server 9, in real time and executed. When this program is executed, program setup information and details of system and application installation of a current terminal OS are analyzed and a user interface screen is output. That is, a background screen structure, menus, icons, folders, widgets and the like are displayed and a configuration of the terminal interface is completed. Operation of the program manager script 20 will be described in detail in the description of FIG. 15.

Widget script 17: A script program developed to operate as a widget. The program manager script 20 loads and executes this program and outputs the execution result as a widget on the screen. This script may be directly downloaded from the market server 91 or may be downloaded in the form included in the program manager script 20. The script is executed as a user interface by the program manager script 20 without being discriminated from the binary widget executed in the OS.

Application script 18: A script program developed to operate as an application. Similar to the widget script 17, the application script may be directly downloaded from the market server 91 or may be downloaded in the form included in the program manager script 20. The application script is executed in the same manner and user interface as the binary application executed in the OS.

Meanwhile, the program manager market server 9 performs a function of managing and downloading various script programs for the sake of the present invention, and includes the following modules:

Market server 91: This is a server module for providing a function of enabling a user to select, purchase and download each script program. The script program is managed and downloaded by combining necessary HTML, CSS, JavaScript, image, and video setup information as one package. The program manager package 92 is a package for downloading the program manager script 20 and may further include an “application script package” and a “widget script package” used by the program manager.

Synchronization server 95: This is a server for storing, in the server, user information 96 and program manager information 97 stored in the terminal and synchronizing the information. The program manager information 97 is obtained by synchronizing setup information and execution storage information of the “program manager” stored in the script and setup storage 23 of the terminal. Accordingly, restoration of this information enables the user interface screen used by the user to be restored as it is. Further, the user information 96 is obtained by synchronizing the “system script” data, such as a user address book, telephone record, SMS information and the like, similar to the type of the “system script” mentioned above.

Remote program manager package 98: This is a “program manager” and is a package whose execution URL is designated as a URL of a remote server. Use of this configuration enables a “program manager script” to be created in real time in the server to configure a screen. Accordingly, this package configures a complex interface to configure a user terminal interface using an external site screen or information as it is by interworking external Internet service.

External service interworking: This is an interface for interworking with an external site when the remote program manager 98 operates or is created using external service information and site as they are. Use of this interworking enables a terminal user interface screen to be configured using a screen of the external site as it is or an integrated user interface to be configured so that a service of the external site is implemented as an icon and executed in the same manner as a terminal application.

FIG. 13 illustrates a structure of the program manager execution layer 24. The program manager execution layer 24 is for providing a user interface by driving the program manager script 20 of the present invention. The program manager execution layer 24 includes a script execution layer 13 including an “HTML & CSS engine” and a “JavaScript engine” that are web browser core modules, and a function of controlling the function of the OS, and a function for managing general programs. Respective configuration modules include:

General program manager 241: A module having a function of providing a list and information of general binary programs installed in the terminal to the script execution layer 13, and executing, deleting, installing and updating the general binary programs in response to a request from the script execution layer 13.

OS program manager interface (I/F) 242: A module for receiving information of a change in a general binary program generated in the terminal by the OS, i.e., installation, deletion, update information. This operation performed by the “program manager” via the script execution layer 13 can be recognized by the “program manager” itself. However, when the program manager execution layer 24 of the present invention is not executed or the execution is interrupted for a while due to insufficient memory of the terminal, the module detects the change in the information. This layer notifies of a change event by interworking with the general program manager 241.

OS use layer 15: A module for providing a function of the OS, i.e., a function that cannot be executed by a general browser, such as process execution cycle control, file system use, database system use, address book, message storage box, widget execution management, and additional equipment use. When the “program manager” calls the OS function via the script execution layer 13 in order to use the OS function, the function is executed through this module.

OS event interworking layer 243: A module providing a function of receiving a variety of changes occurring in the OS in an event form and performing relaying so that the “program manager” performs appropriate operation. This function includes start of a “program manager,” restart of the “program manager” due to insufficient memory, a change of a screen direction, a movement of a widget, a motion of a terminal, a change of a slope, input of a special key, and the like.

Program-manager manager 244: A module for managing the “program managers” installed in the terminal. The program-manager manager 244 manages information of “program managers” downloaded from the program manager market server 9. When a user selects a desired “program manager,” the program-manager manager 244 provides a function of starting up the program and initializing stored “program manager information.”

Synchronization client 245: A module for synchronizing use record and setup information of the “program manager” with the synchronization server 95 of the program manager market server 9. This function enables the user to store a screen structure of the terminal in the server as it is and to perform manipulation while viewing the screen structure of the terminal through WEB since the “program manager” of the present invention operates as it is even in a WEB environment.

Script execution layer 13: A module for performing a function of executing a script program including the “program manager.” That is, the module executes JavaScript and provides an OS access function that is required by the “program manager” and the “system script” while they are being executed. The script execution layer 13 uses an HTML engine and a JavaScript engine to execute JavaScript, provides a JavaScript extension object to use each OS related function, and requests each module described above to execute the function when a call is made in the object and delivers the result to a script program via the JavaScript extension object. Further, the script execution layer 13 provides a function of converting an event generated in the OS into a JavaScript event and delivering the JavaScript event to the currently executed “program manager.”

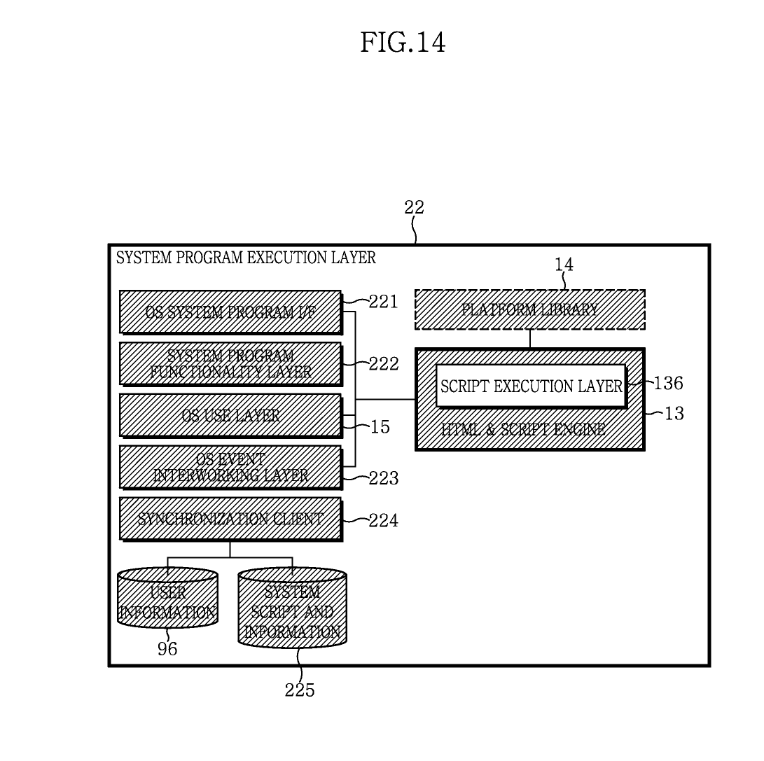

FIG. 14 shows a structure of the system program execution layer 22. This layer uses the same module as the program manager execution layer 24 for execution of the script, and additionally has the following modules:

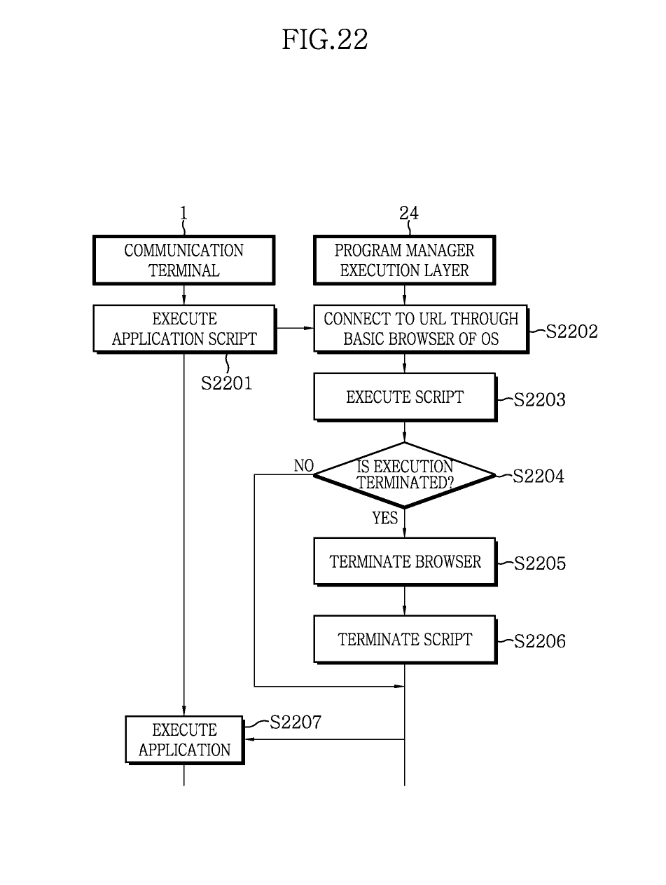

OS system program Interface (I/F) 221: Since the “system script” cannot be recognized as a system program performing a special function in the OS, the interface provides a function for interworking with the OS so that the system program execution layer 22 is recognized as the system program in the OS. For example, for the system program execution layer 22 for executing the “system script” providing a calling function, information indicating that the layer is used as a calling program is registered in the OS, and the layer is used as a calling program by the OS. Accordingly, when the user attempts a call, the system script execution layer 22 is executed and a currently used “system script” is executed to thereby provide a calling function. An execution procedure will be described in detail in the description of FIG. 22.

System program function layer 222: A layer for providing a function required by each system program. The function provided in this layer is registered as a JavaScript object in the script execution layer 13. Accordingly, the “system script” calls the object registered in the script execution layer 13 by calling the platform library 14, and the script execution layer 13 calls the function of the “system program function layer” and provides the execution result to the “system script.” In this manner, unique operation of each “system script” is implemented. For example, for a “calling” program, the system program function layer 222 provides a function related to calling, address book use, and the like.

User information 96: User information managed by the “system script” and including an address book, a SMS message storage box, an image storage box, a telephone record, a schedule, and the like according to functions of the “system script.” This information is synchronized via the synchronization server 95 of the program manager market server 9 in order to store and restore the user information and to enable the “system script” to operate as it is even in the WEB environment. In the present invention, the synchronization of the “program manager” allows the user interface of the user terminal to be used as it is in the WEB, and primary system functions of the communication terminal to be used as they are. In the present invention, implementation of such a function does not require additional development other than a WEB communication function itself.

FIG. 15 illustrates a procedure of outputting a user interface screen to a terminal screen after the terminal is started up. That is, FIG. 15 illustrates a procedure in which a “program manager” is executed.

First, when the terminal is started up, a program manager registered in the OS is searched for by the function of the OS and a registered program manager execution layer 24 of the present invention is executed (S1501). The program manager execution layer 24 is started up from the OS by an OS program manager I/F 221 registered in the OS. This OS program manager I/F 221 is registered in the OS by the program manager execution layer 24 in advance. The OS program manager I/F 221 is registered when the program manager execution layer 24 is first executed by the user.

In this case, the general program manager 241 analyzes execution information of an installed application (APP) to extract and store an icon. In this case, an OS event interworking layer 243 is registered in the OS so that a system event occurring in the OS is received.

Meanwhile, when there is a “program manager” that has been installed in the communication terminal 1 (S1502), the procedure proceeds to S1513, in which the “program manager” is executed. On the other hand, when there is no installed “program manager,” the market server 91 is accessed and a new manager is downloaded from the market server 91.

The market server 91 compares a “program manager” list in the server with a list of program managers installed in the terminal to create a list of downloadable program managers, and displays whether “update” and “delete” are possible. Information of the installation on the terminal is delivered via the program manager 244 of the program manager execution layer 24, and unique IDs and version information of the “program manager” installed in the communication terminal 1 are all delivered.

Next, “download,” “update” and “delete” are displayed for each “program manager” by reflecting the installation information of the communication terminal 1 (S1503), and the program manager package 92 is downloaded by a user selection (S1504) and installed (S1505). The program manager package 92 is a collection of the application script 18 and the widget script 17 associated with the “program manager,” together with a program, an image, sound, a moving image and setup information configuring the “program manager.”

Then, the installed program manager package 92 is analyzed, and execution information and related resources such as script files and images are installed. When it is judged that a “program manager” execution URL indicates an external server based on the execution information (S1506), this “program manager” is a “remote program manager 98.” In this case, the server corresponding to the URL is accessed and programs, images, moving images and the like are executed and necessary information is downloaded (S1507).

If there is “program manager information” corresponding to a unique ID of the “program manager” in the terminal (S1508), the program manager information is used as it is (S1510), and otherwise, a new storage space is created for the unique ID (S1509). Meanwhile, when there is “program manager information” in the server (S1511), the synchronization server 95 is accessed and “setup and use information” is received from the synchronization server 95 (S1512) and stored as “program manager information.”

Next, the “program manager” is executed through an “execution URL” of the execution information of the “program manager” (S1513). In this case, after the program manager is executed, the “program manager” requests the script execution layer 13 to perform “execution lock.” This means requesting the OS use layer 15 to prevent OS interference and control from occurring during initial execution of the “program manager.”

Next, the “program manager” compares the created APP information with the “program manager information” and executes synchronization. The reason for synchronizing each time is that the program manager execution layer 24 according to the embodiment of the present invention may not be executed or a new APP (binary program) may be installed even when the program manager execution layer 24 is in the memory.

Meanwhile, when there are OS-related resources created by another “program manager” that is previously being executed, the “program manager” removes all the resources. In particular, the program manager removes a binary widget of the screen. Then, icons and menus for application execution are displayed based on screen and icon arrangement information stored in the program manager information 97, and the binary widget 16 and the widget script 17 are displayed.

Finally, all user interfaces are displayed on the screen, “execution lock” is released, and an execution standby state in which the user can use the communication terminal 1 is obtained, such that the user can use the communication terminal 1.

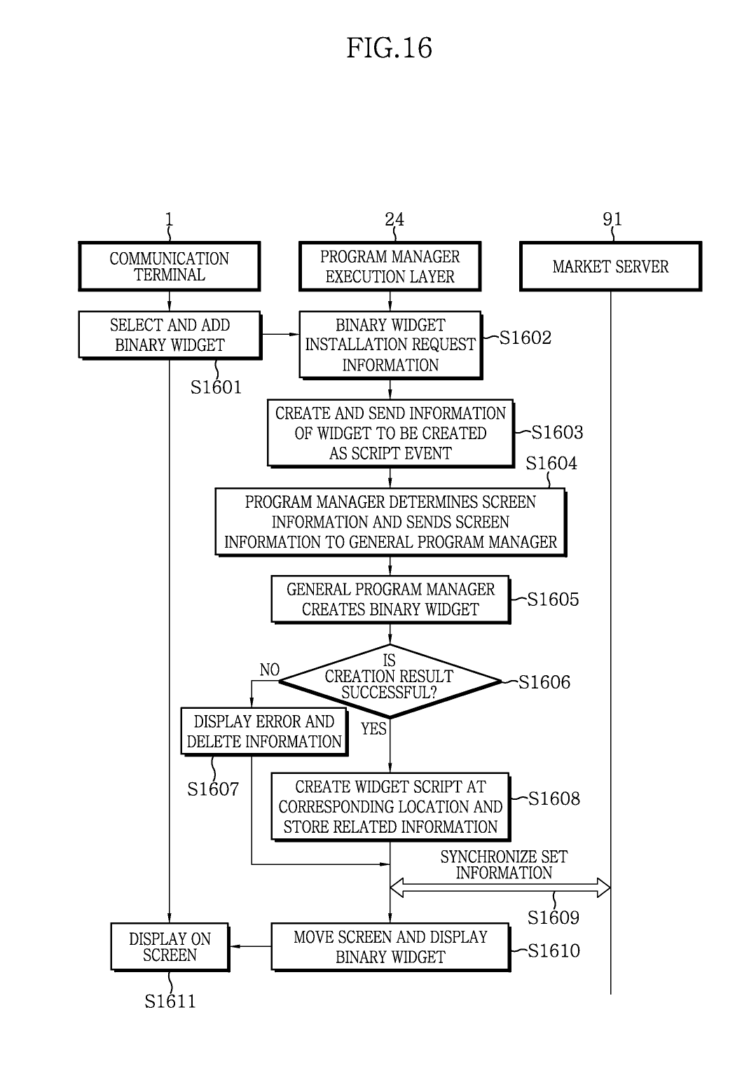

FIG. 16 illustrates a procedure in which the “program manager” of the present invention adds a widget program developed to operate on the OS, i.e., a binary widget 16.

First, the user selects and adds the binary widget 16 using the function of the OS (S1601). Then, installation information for the binary widget 16 is received from the OS via the general program manager 241. In this case, the general program manager 241 analyzes a widget ID, execution information, a title, and icon information of a widget to be created (S1602).

Then, the general program manager 241 creates the information of the widget to be created (i.e., widget ID, icon, execution information, title, and type) as a script event, and the script event is sent to the script execution layer 13. The script execution layer 13 sends a system event to the currently executed “program manager” (S1603).

Then, the currently executed “program manager” receives the event, confirms a screen arrangement manner of a corresponding program and a room of the screen to determine a location and a size for creation, and notifies the general program manager 241 of determination information via the script execution layer 13 (S1604).

Meanwhile, the general program manager 241 creates a binary widget 16 on the screen based on the received information (S1605), and notifies the “program manager” of the creation result as an event via the script execution layer 13.

In this case, when the creation result is successful (S1606), the “program manager” creates a “virtual widget script” to control the binary widget 16 at a corresponding location and stores information related to the binary widget 16 in the “virtual widget script” (S1608). This is for controlling the binary widget 16 through the “virtual widget script” since the “program manager” can directly control the binary widget 16. That is, the “virtual widget script” has a function of controlling the binary widget 16, and the “program manager” directly controls the virtual widget script, like another widget, since the virtual widget script is a script. On the other hand, when the creation result is not successful (S1606), the “program manager” displays an error and deletes the information (S1607). In this case, since the screen configuration information has been changed, this information is stored in the “program manager information. When the creation result is successful (S1606), the “program manager” creates a “virtual widget script” to control the binary widget 16 at a corresponding location and stores information related to the binary widget 16 in the “virtual widget script” (S1608). Further, when the “program manager” is set to be synchronized with the synchronization server 95, modified information is stored in the program manager market server 9 via the synchronization server 95 (S1609).

Finally, the screen is moved to a page and space in which the binary widget 16 is to be output, and the binary widget 16 is displayed (S1610), such that the binary widget 16 is output on the screen (S1611).

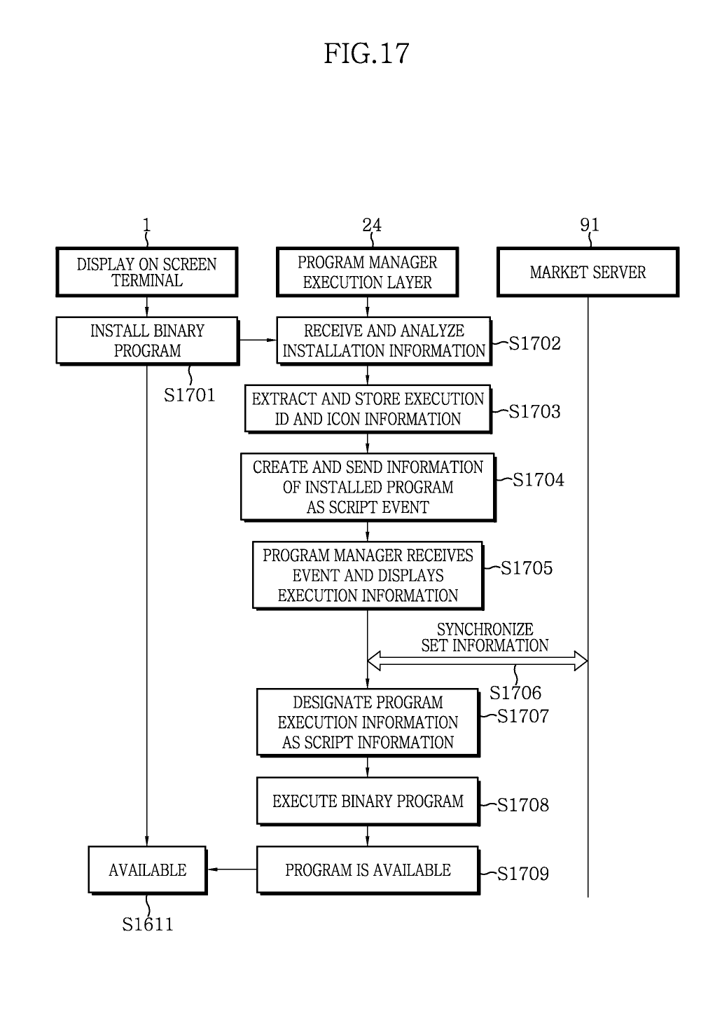

FIG. 17 illustrates a procedure in which the general binary program 12 is registered in the “program manager” of the present invention when the general binary program 12 is executed in the OS so that the “program manager” can manage and execute a “native program” of the OS, i.e., a binary program.

First, the user downloads and installs the “binary program.” Usually, this is a procedure of purchasing and installing software (SW) of the OS (S1701).

In this case, when installation information of the “binary program” is received from the OS via the general program manager 241, a “binary program” package is analyzed (S1702), and an execution ID and icon information of each executable module are extracted and stored in a DB of the program manager execution layer 24 (S1703).

Meanwhile, the general program manager 241 creates a list of execution module information (i.e., icon, execution information, title, and type) of the installed program as a script event, and sends the script event to the script execution layer 13 (S1704).

In this case, the currently executed “program manager” receives the installation event, stores each execution information and displays the execution information on the user interface screen (S1705). The execution information is usually displayed as an icon, but a display manner and a display location depend on an implemented operation of each “program manager.”

Meanwhile, a “program manager” using an icon replacing function may replace the displayed icon with another icon based on user selection or execution information. If the “program manager” is set to be synchronized with the synchronization server 95, the modified information is stored in the program manager market server 9 via the synchronization server 95 (S1706).

The “program manager” designates execution information of a binary program that is added to the execution information corresponding to the icon or menu area of the program (S1707). In this case, the information is implemented by JavaScript. Further, the script is a program for requesting the general program manager 241 to execute the program via the script execution layer 13. Accordingly, when a selection is made by the user, the binary program is executed via the general program manager 241 (S1708), such that the binary program is available (S1709 and S1710).

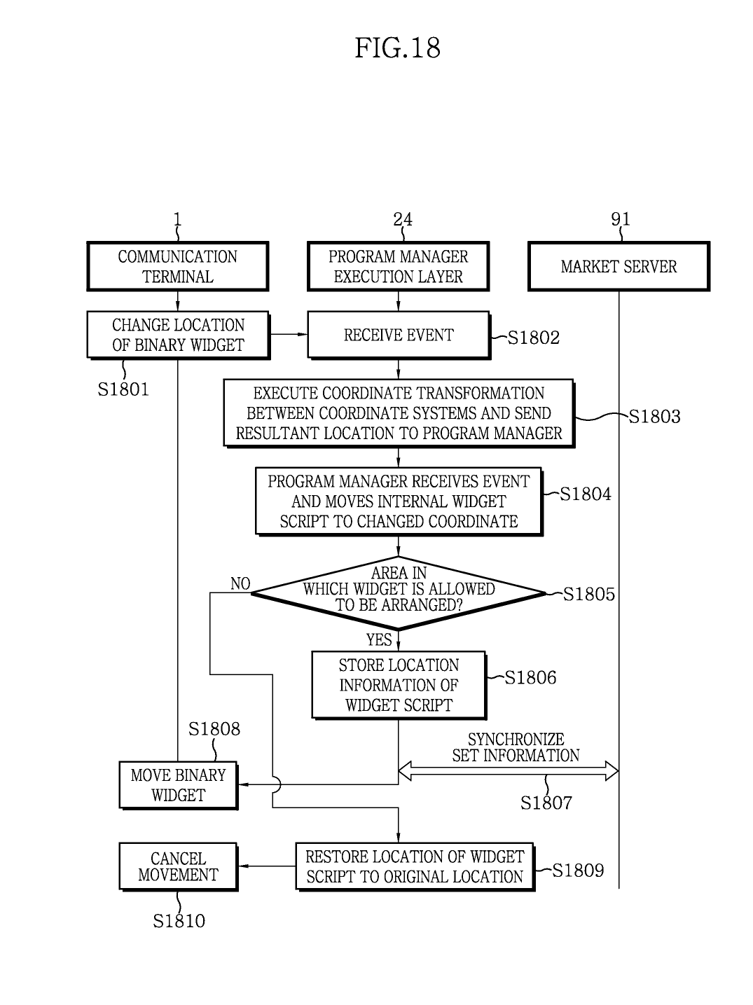

FIG. 18 shows a procedure in which the “program manager” manages a state of the “binary widget” when the state of the “binary widget” is changed. The procedure is for coping with a case in which the binary widget 16 moves out of control of the “program manager,” rather than with a situation in which the “program manager” directly moves the binary widget 16.

First, when the user changes the location of the binary widget 16 on the screen (S1801), the general program manager 241 receives an event related to movement of the binary widget 16 from the OS (S1802).

Then, a coordinate transformation between a coordinate system used in the OS and a coordinate system used in the script execution layer 13 is executed, and the resultant location is sent as an event to the current executed “program manager” via the script execution layer 13 (S1803). That is, a widget ID and location information are sent.

In this case, when receiving the event, the currently executed “program manager” moves an internal “virtual widget script” controlling the binary widget 16 to a changed coordinate (S1804). Meanwhile, when the “virtual widget script” is moved to an area in which the “virtual widget script” is not allowed to be arranged (S1805), a display state of the moving widget is displayed to be in a state in which the virtual widget script cannot be arranged.

When the movement of the binary widget 16 is terminated, the “program manager” identifies a current location of the “virtual widget script.” When the location is in an area in which the widget is allowed to be arranged (S1805), the program manager stores location information of the “virtual widget script” in the DB, completes the movement, and executes step S1806 and subsequent steps. (In this case, the location may be somewhat adjusted according to a manner of implementing the “program manager.” In this case, the general program manager 241 is requested to change the location of the binary widget 16 into that location.) On the other hand, when the location is in an area in which the widget is not allowed to be arranged, S1809 and subsequent steps are omitted.

Accordingly, when the “program manager” is set to be synchronized with the synchronization server 95, modified information is stored in the program manager market server 9 via the synchronization server 95 (S1807). Then, movement of the binary widget 16 is completed (S1808) and displayed at the corresponding location.

On the other hand, in S1809, when the location of the “virtual widget script” is requested to be restored to an original location and the OS is requested to restore the binary widget 16 to an original location via the general program manager 241 (S1809), the movement of the binary widget 16 is cancelled (S1810) and the binary widget 16 returns to the original location.

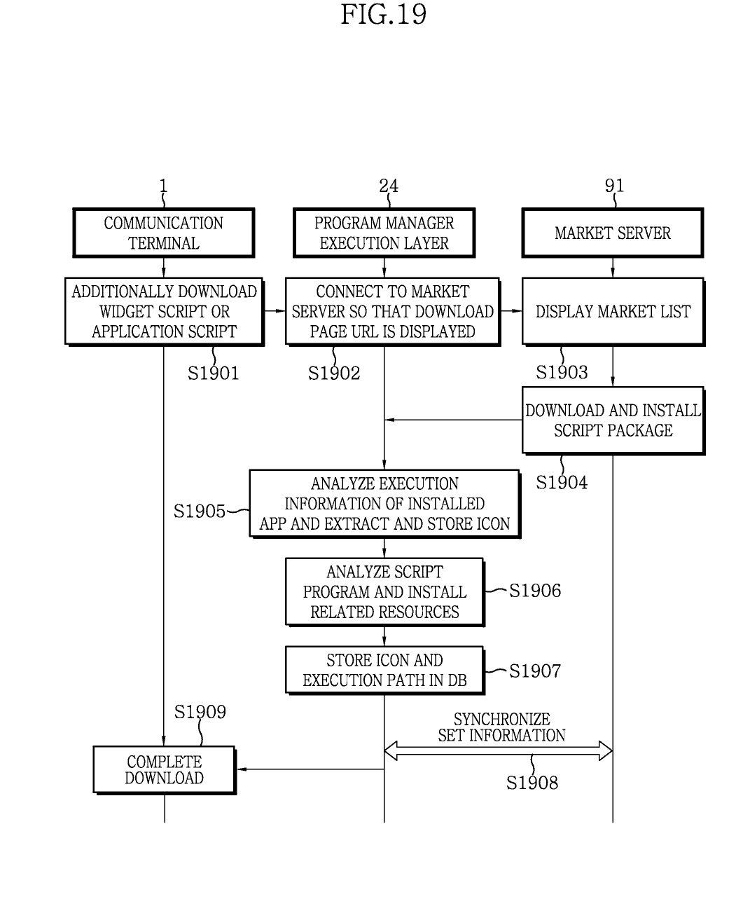

FIG. 19 illustrates a procedure of installing script programs, i.e., the application script 18 and the widget script 17 developed based on the same technique as the “program manager” of the present invention.

The widget script 17 and the application script 18 described above may be included in a “program manager package,” and downloaded and installed through a process, which will be described later, to be used as dedicated programs by the “program manager” (S1901). First, when the user attempts to additionally download the widget script 17 or the application script 18 using an “add application” menu of the program manager execution layer 24, the program manager execution layer 24 connects to a URL of a download page for the widget script 17 and the application script 18 (S1902). That is, the program manager execution layer 24 connects to the market server 91. In this case, the market server 91 compares the “script program” list of the server with the list installed in the terminal to create a downloadable list and displays whether “update” and “delete” are possible (S1903). This installation information on the terminal is delivered via the program manager 244 of the program manager execution layer 24. A unique ID and version information of the script programs installed in the terminal are all delivered.

Then, “download,” “update,” and “delete” are displayed for each script program by reflecting the installation information of the terminal, and the package is downloaded and begins to be installed by a user selection (S1904).

Next, the execution information of the installed script program is analyzed, and an icon is extracted and stored in the DB of the program manager execution layer 24 (S1905). The script program is analyzed and related resources such as an execution script file and an image are installed (S1906).

Meanwhile, in case of the application script 18, an icon or a menu is output on the “user interface screen” and a script execution path is linked. For the widget script 17, when the user uses a widget adding function, information is stored so that the icon and title information are displayed in the list (S1907).

If the “program manager” is set to be synchronized with the synchronization server 95, the modified information is stored in the program manager market server 9 via the synchronization server 95 (S1908).

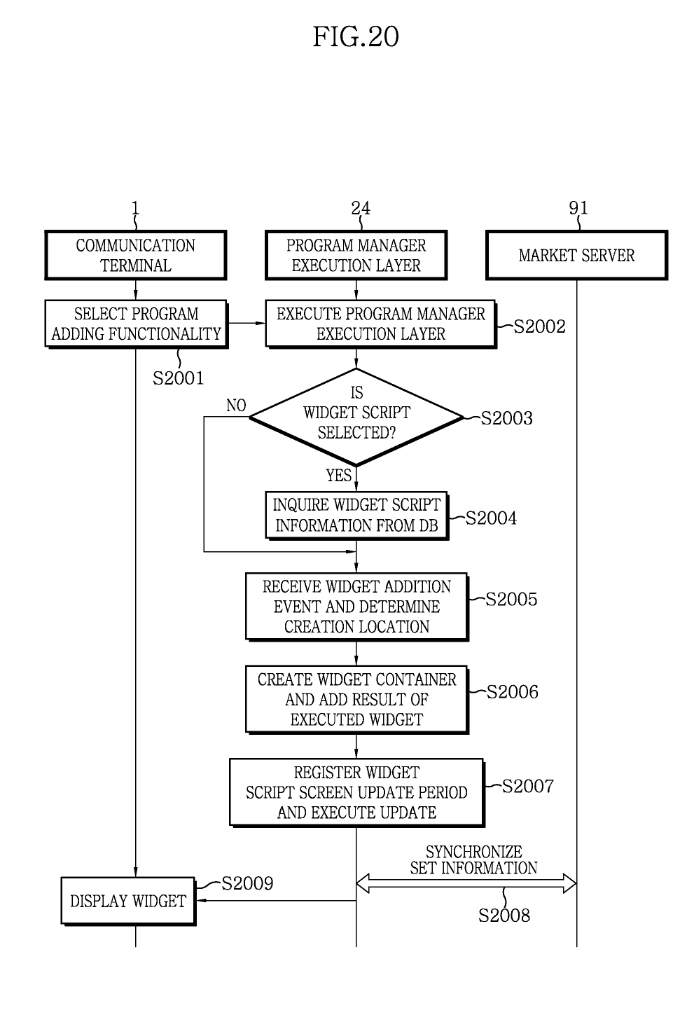

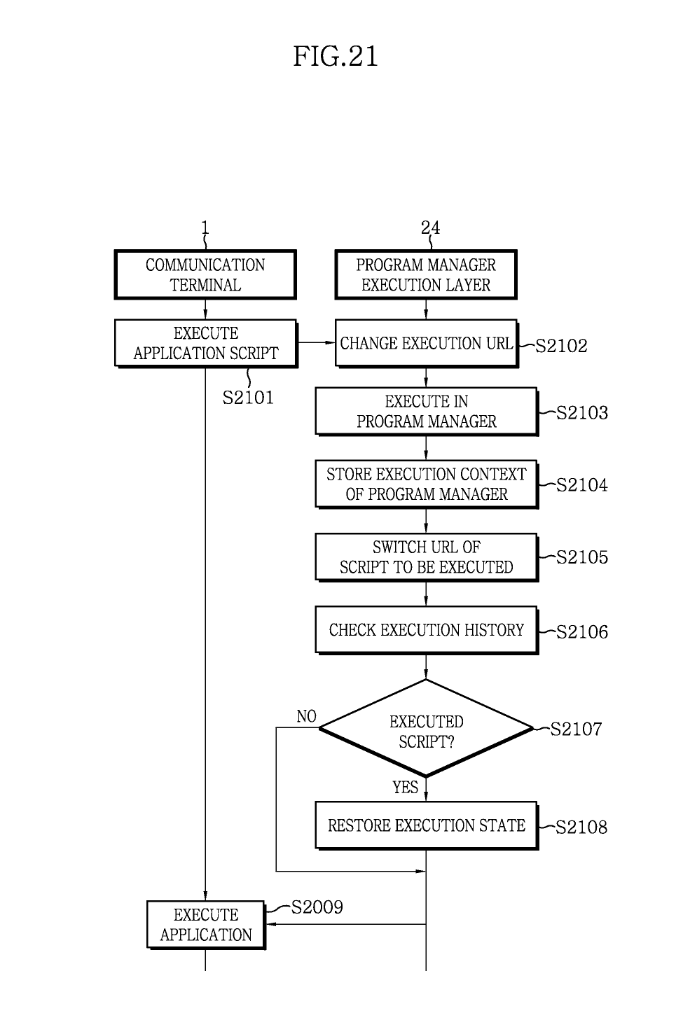

Accordingly, the application script 18 becomes available and the widget script 17 can be added (S1909). In this case, execution of the application script 18 will be described later in FIG. 21, and addition and execution of the widget script 17 will be described in FIG. 20.

FIG. 20 illustrates a procedure in which the widget script 17 is executed and displayed in the “program manager.”

First, when the user uses an “add widget” menu of the program manager execution layer 24 in order to add the widget script 17 or the binary widget 16 to the screen (S2001), the program manager execution layer 24 displays a menu in place of a basic OS function (S2002). The general program manager 241 provides a function of adding the widget script 17 and the application script 18, in addition to the existing general binary program 12 and binary widget 16.

In this case, when the user selects the widget script 17 (S2003), step S2004 and subsequent steps are executed. That is, size and execution information and setup information of the widget script 17 are fetched by inquiring the DB of the “program manager” 244 (S2004). Meanwhile, the currently executed “program manager” receives a widget addition event via the script execution layer 13 to confirm a screen arrangement manner and a room of the screen and determine a creation location and size (S2005).

The “program manager” creates a “widget container” to manage the widget, assigns a necessary screen space, and loads and executes an execution script of the widget script 17 in real time. The resultant screen of the executed widget is added to the “widget container” (S2006).

Further, the “program manager” calls an initialization function of the widget script 17, registers a widget script 17 screen update period based on the setup information of the widget script 17, and periodically executes screen update according to the information (S2007).

Meanwhile, when the “program manager” is set to be synchronized with the to synchronization server 95, modified information is stored in the program manager market server 9 via the synchronization server 95 (S2008).

Finally, a widget resulting from execution of the widget script 17 is displayed on the screen (S200) and is available to the user.

FIGS. 21 and 22 show a procedure in which the application script 18 is executed.

If an application selected by the user is an application script 18, (b) and subsequent steps is executed. That is, the currently executed “program manager” executes a corresponding script based on execution information designated in the icon or the menu (S2101). That is, the program manager connects to an execution URL of the script. In this case, the script is executed in the following three methods according to an execution program for executing the URL.

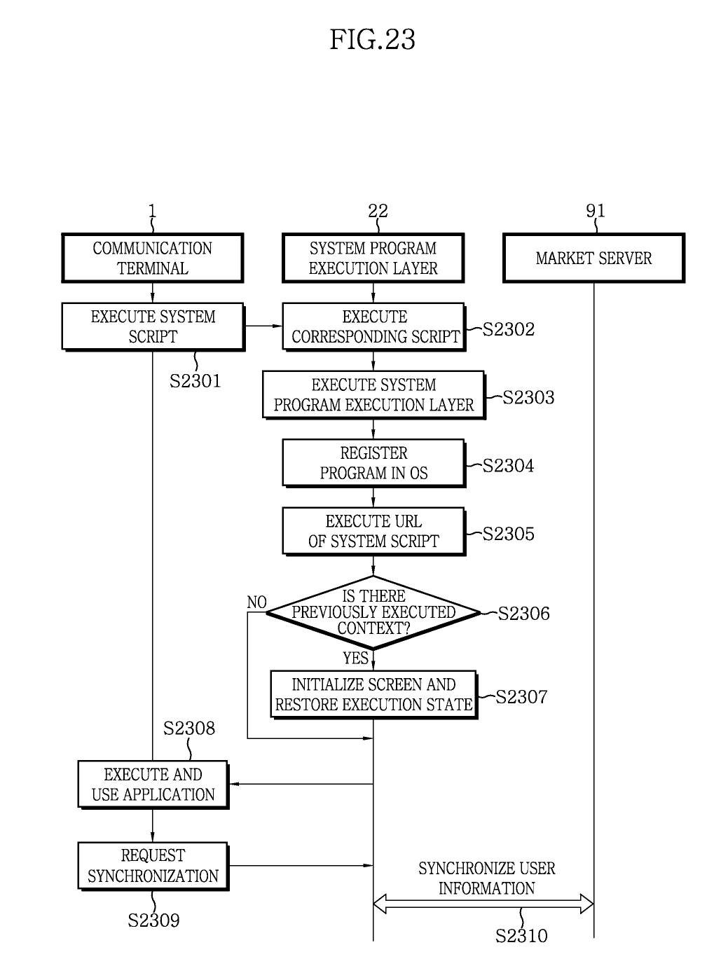

In a first method, as shown in FIG. 21, an execution URL of the program manager execution layer 24 is changed (S2102) and an application script 18 is executed instead of a current “program manager.” In this case, step S2103 and subsequent steps of FIG. 21 are executed. In a second method, the program manager connects to the URL through the basic browser of the OS. In this case, step S2203 and subsequent steps of FIG. 22 are executed. In a third method, a dedicated system program included in the present invention is executed and the URL is executed by the program. In this case, the procedure of FIG. 23 is executed. That is, according to the first method, an execution context of the “program manager” is stored (S2104) and the program manager switches to a URL of a script to be executed (S2105) (i.e., the script is executed). In this case, an execution history of the program manager execution layer 24 is checked (S2106). When this script program is a previously executed script (S2107), the context is read and an execution state is restored (S2108).

Then, the program manager connects to the script URL through the basic browser of the OS (that is, the script is executed), and when the execution is terminated, the browser is terminated and the script is terminated. In this case, management of the execution context depends on an execution manner for the browser. Finally, the application script 18 is executed (S2109) and used by the user.

According to the second method, when the application script is executed (S2201), the program manager connects to a URL through the basic browser of the OS (S2202) and executes the application script 18 (S2203). When the execution is terminated (S2204), the browser is terminated (S2205) and the script is terminated (S2206). Finally, the application script 18 is executed (S2207) and used by the user.

FIG. 23 illustrates a procedure in which the system script program is executed through the system program execution layer 22 to implement a system program function of the terminal. In the present invention, a “system program” is configured as script, and, for the “system program” function, a plurality of programs may be simultaneously used or may be immediately replaced with a program with another UX.

If an application selected by the user is the system script 19 (S230), step S2302 and subsequent steps are executed. That is, the currently executed “program manager” executes a corresponding script based on the execution information designated by the icon (S2302). In this case, when a system program execution layer 22 to be executed is designated in the execution information, the system program execution layer 22 is first executed (S2303) and this program is requested to execute a URL of the script.

When the system program execution layer 22 is executed, a program to execute the system function is registered in the OS (S2304). Accordingly, when a corresponding function is called by the user or another program later, the system program execution layer 22 is executed.

In this case, the system program execution layer 22 executes a URL of the system script 19 via the script execution layer 13 (S2305). When there is a previously executed execution context (S2306), the system script 19 initializes the screen with the information and restores the execution state (S2307).

Meanwhile, in the communication terminal 1, the application is executed (S2308) and used by the user. When the user uses a unique function of the system script 19, the corresponding function is executed in the system program function layer 222 via the script execution layer 13.

Finally, user information is synchronized with the server in response to a request for synchronization from the user or by script setup (S2309 and S2310). The synchronization client 224 of the system program execution layer 22 interworks with the synchronization server 95 to synchronize information managed by the program (this information includes an address book, an SMS message, a gallery (image files), E-mail and the like.)

The apparatus for implementing a web-based user interface for a communication terminal and the method thereof according to the first and second embodiments of the present invention have been described in detail. Hereinafter, an example of a variant and or an application of the present invention will be described.

First, the script execution layer 13 of the present invention is started up and executed in a different manner from a terminal OS to a terminal OS. Execution of the function described herein belongs to the variant of the present invention whether a method of replacing the terminal user interface by starting up this binary program is a formally OS-provided method or a privately developed method.

Second, a manner of developing the OS use layer 15 may differ according to the terminal OS and core modules of a used web browser. That is, plug-in SW may be installed in the web browser or the script execution layer 13 may provide the function while controlling the “web browser core module” in an upper layer. Alternatively, the function may be provided by installing an external separate module and requesting the module to provide the function. All the developing manners belong to variants of the present invention.

Third, in the present invention, the “communication provider portal” does not necessarily refer to only a “portal service” of a “communication provider,” but may also refer to influential general portal providers. That is, the platform of the present invention may also be applied to an Internet provider such as a general portal provider and a game provider according to a degree of openness of the OS. In particular, when the manner of the remote program manager 98 is used, a page and service of the Internet provider are coupled with the terminal user interface as they are.

Fourth, advertisement business conducted by configuring the “program manager” of the present invention and, particularly, the remote program manager 98 with a subject related to advertisement belongs to the present invention. In particular, when the present invention is applied to this business, the present invention can be directly applied without replacement of system modules in the terminal OS when the user replaces the template, such that the present invention can be applied by the user with no burden. A “script program” is dynamically displayed on the background screen, such that dynamically changed related information can be displayed.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An apparatus for implementing a web-based user interface for a communication terminal, the apparatus comprising:
a script execution layer included in the communication terminal, for receiving a script program from a program server and executing the script program together with a platform library;
the platform library included in the communication terminal, for providing at least one function of a graphic user interface, screen rearrangement, context management, terminal engine compatibility, communication, data storage and management, dynamic module management, and animations and effects to the script program;
a program manager included in a program server, designated with a URL by the script execution layer, and downloaded to and executed by the communication terminal, the program manager configuring a terminal user interface based on an interface configuration information data file provided from a program manager server;
the program manager server included in the program server, for managing interface configuration information of the communication terminal for each user and providing the interface configuration information data file in response to a request from the program manager; and
the script program included in the program server and produced using a script and the platform library.

2. A method of implementing a web-based user interface for a communication terminal, the method comprising:
(a) executing a script execution layer of the communication terminal and downloading a program manager of a program server by means of a URL;
(b) creating, by a program manager server, an interface configuration information data file based on customer setup information corresponding to the communication terminal in response to a request from the program manager, configuring the customer setup information using a basic template in advance when there is no customer setup information, and providing the created interface configuration information data file to the program manager;
(c) analyzing, by the program manager, the interface configuration information data file and configuring the user interface in the communication terminal; and
(d) analyzing, by the program manager, dynamic execution information included in the interface configuration information data file, connecting to a URL of a program in an “executed” state, and downloading and executing a corresponding script program.

3. A method of implementing a web-based user interface for a communication terminal, the method comprising:
(a) receiving, by a web-based user interface, a program selection from a user;
(b) identifying, by a program manager, a type of a program based on link information of the program;
(c) when the type of the program indicates a script program, connecting to a URL of the script program and downloading and executing the script program, wherein, when the script program is a program deactivated due to program switching by a user, a script program stored in a temporary storage of the communication terminal is directly executed; and
(d) when the program type indicates a general binary program, executing the general binary program by means of an operating system, wherein the program manager manages a state of the general binary program by a general program manager of a script execution layer providing a program execution state to the program manager using a system call of the operating system.

4. The method according to claim 3, further including, when the script program includes a context management function in step (c):
(c1) loading a context of the script program managed by a platform library directly after the script program is executed; and
(c2) storing a change of a screen and data resulting from execution of the script program, in the context of the script program.

5. A method of implementing a web-based user interface for a communication terminal, the method comprising:
(a) receiving, by a program manager, a selection of a program-adding function from a user;
(b) downloading, by the program manager, a setup program to a communication terminal such that the setup program is executed, and receiving, by the setup program, a general binary program list from a general program manager of a script use layer and a list of script programs and general binary programs available to the user from a program manager server; and
(c) when a program added by the user is a general binary program installed in the communication terminal,
(c1) receiving, by the setup program, program information of the general binary program from the general program manager and delivering the program information together with information on a screen location at which the general binary program is to be added, to the program manager server to request registration;
(c2) registering, by the program manager server, the program information and the screen location information in customer setup information, creating an interface configuration information data file based on changed customer setup information, and delivering the interface configuration information data file to the program manager; and
(c3) analyzing, by the program manager, the interface configuration information data file and displaying an icon and information of the registered program.

6. A method of implementing a web-based user interface for a communication terminal, the method comprising:
(a) receiving, by a program manager, a selection of a program-adding function from a user;
(b) downloading, by the program manager, a setup program to the communication terminal such that the setup program is executed, and receiving, by the setup program, a list of general programs installed by the user from a general program manager of a script use layer, and a list of script programs and general binary programs available to the user from a program manager server; and
(c) when a program added by the user is a script program present in a program server,
(c1) delivering, by the setup program, a program ID of the script program together with information on a screen location at which the script program is to be added, to the program manager server to request registration;
(c2) registering, by the program manager server, program information corresponding to the program ID and the screen location information, in customer setup information, creating an interface configuration information data file based on changed customer setup information, and delivering the interface configuration information data file to the program manager; and
(c3) analyzing, by the program manager, the interface configuration information data file and displaying an icon and information of a registered program.

7. A method of implementing a web-based user interface for a communication terminal, the method comprising:
(a) receiving, by a program manager, a selection of a program-adding function from a user;
(b) downloading, by the program manager, a setup program to the communication terminal such that the setup program is executed, and receiving, by the setup program, a list of general programs installed by the user from a general program manager of a script use layer, and a list of script programs and general binary programs available to the user from a program manager server; and
(c) when a program added by the user is a general binary program in a program server,
(c1) delivering, by the setup program, a program ID of the general binary program together with information on a screen location at which the general binary program is to be added, to the program manager server to request registration;
(c2) registering, by the program manager server, program information corresponding to the program ID and the screen location information, in customer setup information;
(c3) downloading, by the general program manager, an installation file for the general binary program and installing the general binary program in the communication terminal;
(c4) creating, by the program manager server, an interface configuration information data file based on changed customer setup information and delivering the interface configuration information data file to the program manager; and
(c5) analyzing, by the program manager, the interface configuration information data file and displaying an icon and information of a registered program.

8. An apparatus for implementing a web-based user interface for a communication terminal, the apparatus comprising:
a program manager execution layer included in the communication terminal, responsible for use of an operating system (OS) function and execution of a script;
a system program execution layer for executing a process for each system function according to the OS;
a platform library included in the communication terminal, for providing at least one function of a graphic user interface, screen rearrangement, context management, terminal engine compatibility, communication, data storage and management, dynamic module management, and animations and effects, to a script program;
an OS use layer for providing an interface for enabling the platform library to provide a function of a terminal system;
a remote program manager package included in a program server, designated with a URL by a script execution layer, and downloaded to and executed by the communication terminal, the remote program manager package configuring a terminal user interface based on an interface configuration information data file provided from a program manager server;
a market server included in the program server, for managing interface configuration information of the communication terminal for each user and providing the interface configuration information data file in response to a request from the remote program manager package; and
a script program included in the program server and produced using the script and the platform library.

9. The apparatus according to claim 8, wherein the terminal system function of the OS use layer includes at least one function of an application management function, a widget management function, OS event notification, telephone/SMS service, data transmission, shared file access, personal data access, and system setup.

10. The apparatus according to claim 8, further comprising a synchronization server for synchronizing, in a program manager market server, user information and program manager information stored in the communication terminal with the market server.

11. A method of implementing a web-based user interface for a communication terminal, the method comprising:
(a) when the communication terminal is started up, executing a program manager execution layer by means of a function of an operating system (OS);
(b) analyzing, by a general program manager, execution information of an installed application and extracting and storing an icon;
(c) when there is an installed program manager in the communication terminal, executing the program manager; and
(d) when there is no installed program manager in the communication terminal, connecting to a market server and downloading and executing a new program manager.
